(19) United States
(12) Patent Application Publication
(10) Pub. No.: US 2017/0364933 A1
(43) Pub. Date: Dec. 21, 2017

(54) USER MAINTENANCE SYSTEM AND METHOD

(71) Applicant: BEIJING DIDI INFINITY TECHNOLOGY AND DEVELOPMENT CO., LTD., Beijing (CN)

(72) Inventors: Guobao CHEN, Beijing (CN); Chengxiang ZHUO, Beijing (CN); Ming XU, Beijing (CN); Tong ZHANG, Beijing (CN); Haiyang LU, Beijing (CN); Kaijie QIN, Beijing (CN); Qi SONG, Beijing (CN)

(73) Assignee: BEIJING DIDI INFINITY TECHNOLOGY AND DEVELOPMENT CO., LTD., Beijing (CN)

(21) Appl. No.: 15/533,994

(22) PCT Filed: Dec. 9, 2015
(86) PCT No.: PCT/CN2015/096820

§ 371 Date: Jun. 7, 2017

(30) Foreign Application Priority Data
Dec. 9, 2014 (CN) 201410747783.X
Dec. 9, 2014 (CN) 201410748736.7
Feb. 11, 2015 (CN) 201510073140.6
Feb. 12, 2015 (CN) 201510075387.1
Feb. 13, 2015 (CN) 201510079224.0
Apr. 28, 2015 (CN) 201510209565.5
Jun. 30, 2015 (CN) 201510373596.4

(51) Int. Cl. G06Q 30/02; G06F 17/30; G06Q 10/06; G06Q 50/30

(52) U.S. Cl. CPC G06Q 30/0202; G06Q 10/067; G06F 17/30876; G06F 17/30705; G06Q 50/30

(57) ABSTRACT

The present disclosure relates to a method for predicting an order value. The method includes: obtaining information, wherein the information includes a historical order; determining an attribute feature of the historical order based on the information; and predicting the order value based on the attribute feature. The present disclosure also relates to a system for predicting the order value. The system includes a receiving module and a processing module, wherein the processing module is configured to predict the order value.

### CROSS-REFERENCE TO RELATED APPLICATIONS

This application claims priority of Chinese Application No. 201410747783.X filed on Dec. 9, 2014, Chinese Application No. 201410748736.7 filed on Dec. 9, 2014, Chinese Application No. 201510073140.6 filed on Feb. 11, 2015, Chinese Application No. 201510075387.1 filed on Feb. 12, 2015, Chinese Application No. 201510079224.0 filed on Feb. 13, 2015, Chinese Application No. 201510209565.5 filed on Apr. 28, 2015, and Chinese Application No. 201510373596.4 filed on Jun. 30, 2015, the entire contents of each of which are hereby incorporated by reference.

### TECHNICAL FIELD

This application relates generally to a system and method for maintaining a user, and in particular, to a system and method for maintaining a user by using mobile Internet technologies and data processing technologies.

### BACKGROUND

With a rapid development of the city, transportation services are in high demand for people from different sectors of society. Meanwhile, with a rapid development of mobile Internet technology and smart devices, especially intelligent navigation systems and smart phones, taxi platforms have become more and more popular, which may bring great convenience for people to travel. More and more users may use taxi applications provided by different companies. Therefore, for each company, maintaining users is of great significance. It is important to seek an improved solution to maintain users and to enhance user experience to attract and maintain more users.

### SUMMARY

In one aspect of the present disclosure, a method for predicting an order value is provided. The method may include obtaining information, wherein the information includes information of a historical order; determining an attribute feature of the historical order based on the information; and predicting a value of a target order based on the attribute feature of the historical order.

In another aspect of the present disclosure, a system for predicting an order value is provide. The system may include a non-transitory computer-readable storage medium configured to store an executable module, comprising: a receiving module configured to receive information, wherein the information includes information of a historical order; a processing module configured to determine an attribute feature of the historical order and to predict a value of a target order; and a processor configured to execute the executable module stored in the non-transitory computer-readable storage medium.

In some embodiments, the attribute feature of the historical order may include at least one of a value of historical order (also referred to herein as a “historical order value”), an activity of order (also referred to herein as an “order activity” or an “order activity feature”), or a feature relating to an order (also referred to herein as an “order-related feature”).

In some embodiments, the determining of the attribute feature of the historical order may include: obtaining a plurality of users submitting order requests for the historical order; obtaining the number of order requests submitted by each of the plurality of users within a predetermined time period; and determining the value of the historical order based on the number of order requests submitted by each of the plurality of users.

In some embodiments, the determining of the attribute feature of the historical order may include: determining an initial order value for each of a plurality of historical orders based on the order activity feature; determining a final order value for each of the plurality of historical orders based on the initial order value and the attribute feature; and determining the historical order value based on the final order value of each of the plurality of orders.

In some embodiments, the determining of the initial order value of each of the plurality of historical orders may include: weighting the order activity feature of each of the plurality of historical orders; smoothing one or more order activity features associated with a greater weight; and determining the initial order value of each of the plurality of historical orders based on the smoothed order activity features.

In some embodiments, the determining of the final value of each of the plurality of historical orders may include: weighting the attribute feature of each historical order; smoothing the attribute feature associated with a greater weight; and determining the final order value for each of the plurality of historical orders based on the initial order value and the attribute feature smoothed.

In some embodiments, the method for predicting an order value may further include: obtaining historical orders associated with a target order; determining historical order values based on the number of order requests submitted by each of the plurality of users within a predetermined time period; and predicting the target order value based on the historical order values.

In some embodiments, the method for predicting an order value may further include generating a mapping model based on the order-related feature and the order value.

In some embodiments, the method for predicting an order value may further include obtaining data relating to the target order; and predicting the target order value based on the mapping model and the data relating to the target order.

### BRIEF DESCRIPTION OF THE DRAWINGS

Figures herein are provided for further understanding of the present disclosure, and constitute a part of this present disclosure. The exemplary embodiments of the present disclosure and the description are used to explain the present disclosure, and are not intended to be limiting.

FIG. 1 is a diagram of an exemplary system for maintaining users according to some embodiments of the present disclosure;

FIG. 2 is a flowchart of an exemplary process for maintaining users according to some embodiments of the present disclosure;

FIG. 3 is a block diagram of an exemplary system for maintaining users according to some embodiments of the present disclosure;

FIG. 4 is a flowchart of an exemplary process for determining an order value according to some embodiments of the present disclosure;

FIG. 5A is a flowchart of an exemplary process for determining a historical order value according to some embodiments of the present disclosure;

FIG. 5B is a flowchart of an exemplary process for determining a target order value according to some embodiments of the present disclosure;

FIG. 5C is a block diagram of an exemplary server for determining the order value according to some embodiments of the present disclosure;

FIG. 6A is a flowchart of another exemplary process for determining a historical order value according to some embodiments of the present disclosure;

FIG. 6B is a block diagram of another exemplary server for determining the historical order value according to some embodiments of the present disclosure;

FIG. 7A is a flowchart of an exemplary process for predicting an order value according to some embodiments of the present disclosure;

FIG. 7B is a block diagram of an exemplary server for predicting the order value according to some embodiments of the present disclosure;

FIG. 8 is a flowchart of an exemplary process for determining a user stability according to some embodiments of the present disclosure;

FIG. 9A is a flowchart of another exemplary process for determining the user stability according to some embodiments of the present disclosure;

FIG. 9B is a block diagram of an exemplary server for determining the user stability according to some embodiments of the present disclosure;

FIG. 10A is a flowchart of an exemplary process for determining a user loss boundary according to some embodiments of the present disclosure;

FIG. 10B is a block diagram of an exemplary server for determining the user loss boundary according to some embodiments of the present disclosure;

FIG. 11 is a flowchart of an exemplary process for determining a user lifecycle and maintaining users according to some embodiments of the present disclosure;

FIG. 12A is a flowchart of an exemplary process for determining a classification of user friendship according to some embodiments of the present disclosure;

FIG. 12B is a block diagram of an exemplary server for determining the classification of user friendship according to some embodiments of the present disclosure;

FIG. 13A is a flowchart of an exemplary process for recognizing a user according to some embodiments of the present disclosure;

FIG. 13B is a flowchart of another exemplary process for recognizing the user according to some embodiments of the present disclosure; and

FIG. 13C is a block diagram of an exemplary server for recognizing the user according to some embodiments of the present disclosure.

### DETAILED DESCRIPTION

In the following detailed description, numerous specific details are set forth by way of example in order to provide a thorough understanding of the relevant disclosure. Various modifications to the disclosed embodiments will be readily apparent to those skilled in the art, and the general principles defined herein may be applied to other embodiments and applications without departing from the spirit and scope of the present disclosure. Unless apparent from the locale or otherwise stated, like reference numerals represent similar structures or operation throughout the several views of the drawings.

As used herein, the singular forms “a,” “an,” and “the” may be intended to include the plural forms as well, unless the context clearly indicates otherwise. It will be further understood that the terms “comprises,” “comprising,” “includes,” and/or “including” when used in this specification, specify the presence of stated features, integers, steps, operations, elements, and/or components, but do not preclude the presence or addition of one or more other features, integers, steps, operations, elements, components, and/or groups thereof.

The present disclosure includes some references to some modules in some the embodiments of the system in the present disclosure. However, a different number of modules can be used and run on the client and/or server. The modules are illustrative only, and different aspects of the system and method may be performed in different modules.

In the present disclosure, some flowcharts are used to illustrate some processes performed by the system according to some embodiments of the present disclosure. It should be noted that the foregoing or the following operations may not be performed in the order accurately. Instead, some step may be performed in the reverse order or simultaneously. Also, some operations may be added in the processes, or one or more steps may be removed from the processes.

The system or method of the present disclosure may be applied to different transportation systems. The different transportation systems may include land, ocean, aerospace, or the like, or any combination thereof. The vehicle of the transportation systems may include a taxi, a private car, a hitch, a bus, a train, a bullet train, a high-speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may include a webpage, a plug-in of a browser, a client terminal, a custom system, an internal analysis system, an artificial intelligence robot, or the like, or any combination thereof. It should be noted that the application of the system or method described is merely an example, for those of ordinary skill in the art, without creative efforts, it can also be used in other similar situations based on the figures, e.g., a user maintenance system.

The term “passenger,” “requester,” “service requester,” “demander,” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. In addition, the term “user” may be a service requester or a service provider.

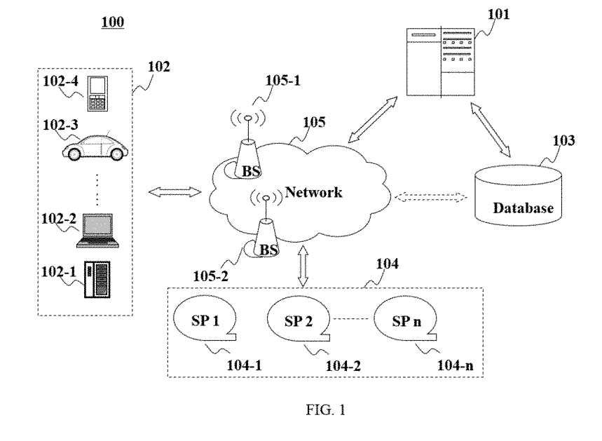

FIG. 1 illustrates an exemplary diagram of system configuration 100 according to some embodiments of the present disclosure. The system configuration 100 may include user maintenance systems 101, service requesters 102, databases 103, service providers 104, and networks 105. In some embodiments, the user maintenance system 101 may be configured to analyze the information obtained to generate an analytical result. The user maintenance system 101 may be a server, a server group, etc. The server group may be centralized, e.g., a data center. The server group may be distributed, e.g., a distributed system. The user maintenance system 101 may be local or remote. The service requester 102 may be referred to as an individual, a device, or other entity that can be used to generate a service order. The service requester 102 may include a desktop computer 102-1, a laptop computer 102-2, a built-in device of a vehicle 102-3, a mobile device 102-4, or the like, or any combination thereof. The user maintenance system 101 may directly access information stored in the database 103 or may access information of the user 102/104 through the network 105.

In some embodiments, the database 103 may be a device that is capable of storing information. The database 103 may be used to store the information obtained from the service requester 102 or the service provider 104 and the information generated by the user maintenance system 101. The database 103 may be local or remote. The connection or communication between the database 103 and other modules in the system may be wired or wireless. The network 105 may provide a channel for exchanging information. The network 105 may be a single network or a combination of networks. For example, the network 105 may include a local area network (LAN), a wide area network (WAN), a public network, a private network, a proprietary network, a wireless network, a virtual network, a public switched telephone network (PSTN), or any combination thereof. The network 105 may include multiple network access points, such as a wired access point, a wireless access point, a base station, or a network switch point. Through the network access points, a data source may be connected to the network 105 and transmit information via the network 105.

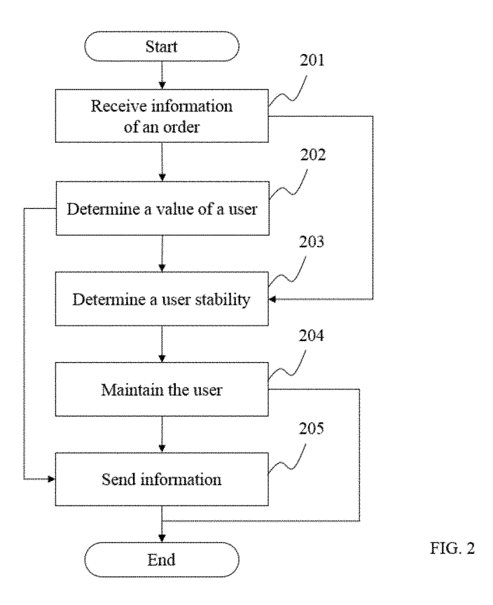

FIG. 2 is a flowchart of an exemplary process for maintaining users according to some embodiments of the present disclosure. In step 201, information of an order may be received from the user 102/104 (see FIG. 1). The user 102/104 may include a server or a communication terminal. Further, the server may include a web server, a file server, a database server, an FTP server, an application server, a proxy server, or the like, or any combination thereof. The communication terminal may include a phone, a personal computer, a wearable device, a tablet computer, a smart television, a built-in device of a vehicle, or the like, or any combination thereof. Furthermore, in step 201, the information of the order may be received by any communication terminal. Further, in step 201, information from other information source 306 may also be received. The information of the order may be in the form of text, images, audios, videos, or the like, or any combination thereof. The information of the order may include information of one or more historical orders or information of one or more real-time order. The information of the order may include a starting location, a destination location, a starting time, an arrival time, a mileage, a price, a price markup by the service requester, a price adjustment by the service provider, a price adjustment by the system, a usage of red packets, an order completion status, an order selection status by the service provider, an order transmission status by the service requester, or the like, or any combination thereof. In some embodiments, part of the information of the order may include real-time information. The real-time information may include the information of orders at a time instant or within a time period. The time period may include a few seconds, a few minutes, a few hours, a customized time period based on a user preference, or a certain time, such as working days, weekends, holidays, peak hours, off-peak hours, etc. The information of the historical order(s) may include some information relating to the past, including, for example, the number of orders completed, the number of orders requested, the number of orders accepted, a completion rate of orders, or the like, or any combination thereof. One embodiment of the information of an order is that the order at one time instant is strived by several service providers. The striving for an order may refer to that business staffs in different retail organizations or one retail organization of one market, may strive for the same order. According to some embodiments of the present disclosure, the market may include a taxi market, an express market, a special car market, or the like, or any combination thereof. In another embodiment, a user (a driver or a passenger) may invite a friend or share the information of the order with a friend in a time period. The information of historical order(s) may be used to predict and/or obtain information or events relating to historical information at the same time instant or time period in the past. User information may refer to information relating to the service requester/service provider. The user information may include a name, a nickname, a gender, age, a telephone number, an occupation, a rank, time of use, driving experience, a vehicle age, a vehicle type, a license plate number, a driver's license number, a certification status, user habits/preferences, additional service capabilities (additional features such as the size of the trunk of the car, a panoramic sunroof, etc.), an order number, location information, or the like, or any combination thereof. Other information in the other information source 306 may refer to the information that is not under the control of the service requester(s) or the service provider(s), or refer to the temporary/unexpected information. Other information may include, but is not limited to, weather conditions, environment conditions, road conditions (the case that a road is closed because of security or road works), or the like, or any combination thereof. Step 201 may be performed by the receiving module 301 in the user maintenance system 101.

In step 202, a value of a user (also referred herein as a “user value”) and a value of an order (also referred herein as an “order value”) may be determined based on the received information. The received information may include, but is not limited to, historical information, user information, other information, or the like, or any combination thereof. The user value may be determined based on the value(s) of the historical order(s) (also referred to herein as the “historical order value”) or the user information. The user value may be divided into one or more levels, for example, two levels, three levels, or any other number of levels. In some embodiments, the user value may be classified into three levels, such as “high,” “normal,” and “low.” In some embodiments, the user value may be classified into five levels, such as “very high,” “high,” “normal,” “low,” and “very low.” In some embodiments, the user value and the corresponding level may be determined based on information relating to the historical order(s). Information relating to the historical orders may include, but is not limited to, the historical order value, feature information of the historical orders, user information relating to the historical orders, or other information relating to the historical orders. In some embodiments, the user value and the corresponding level of the user may be determined by building one or more models. For example, the method may include identifying a plurality of historical orders relating to the user, extracting part of correlation features of the plurality of historical orders within a time period, and determining an average value of the plurality of historical orders based on an integrated model relating to the correlation features extracted and weights. The correlation features may include, but are not limited to, the number of orders placed by a service requester, the number of times striving for one or more orders by a service provider, the time interval from the time when an order is published to the time when a driver strives for the order (also referred to herein as the “striving time”), a platform benefit, an order distance, an order cost, a tip, the number of days from the time when the order is published, an order evaluation, or the like, or any combination thereof. The integrated model may be integrated by using one or more data processing algorithm, including, but not limited to, digitization, smoothing processing, weight adjustment, normalization, the least square method, the local average method, the k nearest neighbor average method, the median method, or the like, or any combination thereof. In some embodiments, the user value may be determined based on the user information. The user information may include, but is not limited to, a name, a nickname, a gender, age, a telephone number, an occupation, a rank, time of use, driving experience, a vehicle age, a vehicle type, a license plate number, a driver's license number, a certification status, user habits/preferences, additional service capabilities (additional features such as the size of the trunk of the car, a panoramic sunroof, etc.), an order number, location information, or the like, or any combination thereof. The user value may be determined based on a user information model. For example, one order that a user requests for many times may be a high-value order, and the user may be a high-value user. As another example, in a friend category of a user, if there may be one or more high-value friends, based on the friend category and a model, the user may be determined as a high-value user. The order value may be determined based on the value(s) of historical order(s) or the user value(s). The order value may be classified into two levels, three levels, four levels, five levels, six levels and so on. For example, the order value may be classified into three levels, such as “good,” “normal,” and “poor.” As another example, the order value may be classified into five levels, such as “very good,” “good,” “normal,” “poor,” and “very poor.” Features used to determine the order value may include, but are not limited to, the number of orders placed by the service requester(s), the number of times striving for one or more orders by a service provider, the striving time, a platform benefit, an order distance, an order cost, a tip, the number of days from the time when the order happens, an order evaluation, or the like, or any combination thereof. In one embodiment, a real-time order value may be determined based on historical order values in the same time instant/time period and a predictive model. In another embodiment, if the number of drivers striving for an order is more, the value of the order may be higher. In another embodiment, the more if the number of drivers striving for an order is more and the drivers striving for the order in a predetermined time period are with a higher completion rate, the value of the order may be predicted to be higher based on the predictive model. In another embodiment, the higher the value of a user is, the higher the value of an order that the user requests/receives may be. Step 202 may be performed by the analyzing module 302 and/or the processing module 303 in the user maintenance system 101.

In step 203, a user stability may be determined. The user stability may be determined by the user value determined in step 202, the order information, the historical order information and a user behavior variable received in step 201 or other information that may be used to determine the user stability. In some embodiments, the user stability may be determined based on one or more models. The models may include, but are not limited to, logistic regression, decision tree, Rocchio, naive Bayes, neural network, support vector machine, linear least squares fit, k nearest neighbors, genetic algorithm, maximum entropy, or the like, or any combination thereof. The model(s) used to determine the user stability may be fixed or adaptive. The step of determination of the user stability may aim at all users, high-value users only, or low-value users only. In one embodiment, after a user is determined to be a high-value user in step 202, through processing one or more behavior variables of the high-value user, the user stability may be determined based on the model. The user stability of a user may represent or be used to predict a loss possibility of the user. For instance, the evaluation to the user stability may be easy to lose, not easy to lose, difficult to lose, or other evaluation related to the loss possibility of the user. The operating data of the user behavior variables may include, but is not limited to, a last used time, a smoothing value of the time intervals of using, a smoothing value of the fluctuating value(s) of the time intervals of using, the current time, the time interval(s) of not using, or the like, or any combination thereof.

In step 204, the user may be maintained. The maintenance may be based on the user stability obtained in step 203. In some embodiments, if a user is determined to be easy to lose, more maintenance services may be provided to the user during the maintenance. The maintenance service may include, but is not limit to, red packets, tips, discount coupons, platform subsidies, pushing higher level users, providing more additional services (e.g., better vehicle types, more space, etc.), or the like, or any combination thereof. In some embodiments, the red packet may refer to an expression of emotional reward in a relationship. According to some embodiments of the present disclosure, the red packet may be in the form of an actual amount of money for a passenger. In some embodiments, for a passenger, when he pays for an order, he may use a red packet to pay part of the order cost. The tip may refer to a reward that is afforded by a service requester to a service provider in a service industry. According to some embodiments of the present disclosure, the tip may be an additional fee that a passenger pays to a driver besides the order cost. In some embodiments, for a passenger, if he publishes an order for several times, but there is no driver that accepts the order, he may provide a tip to improve drivers' willingness to accept the order. In some embodiments, the system platform may determine that an order of a passenger is in non-peak hours, that the destination location of the order is in a remote area, and/or that the passenger is easy to lose. If a driver accepts few number of orders, the system platform may provide some subsidies, e.g., a subsidy for an unoccupied vehicle on a return trip to maintain the passenger and to make up the few number of orders. In another embodiment, if the system platform determines that a passenger is difficult to lose, the passenger may not be maintained. Alternatively, the user may be maintained to avoid loss of the user in future. In another embodiment, during the maintenance, if there are too many user IDs, the user IDs may be identified to determine a unique identifier. Then the user may be maintained based on the unique identifier. Step 204 may be performed by the analyzing module 302 and/or the processing module 303 in the user maintenance system 101.

In step 205, some information may be sent to service requesters, service providers, or third-party platforms. The information sent may include, but is not limit to, the user value(s), the order value(s), the maintenance information, the information shared with friends, or the like, or any combination thereof. Based on the information shared with friends and a classification method used to classify a friendship, the friendship may be analyzed and classified further. The friendship may include a potential relationship or an obvious relationship. The information shared with friends may include public information or selectively public information. The information shared with friends may include, but is not limit to, user information, order information, special offers, location information, carrying capacity information, traffic jam information, traffic information, shared coupons, information that a friend may help to pay, information that a friend may help to accept an order, or the like, or any combination thereof. For example, passenger A and passenger B are in a relationship, and they are going to date in Xidan. Passenger A starts from East Third Ring road and passenger B starts from North Fourth Ring road. Passenger A and passenger B may share the real-time traffic information and/or traffic jam information around Xidan with each other. The information may also be shared unilaterally. Additionally, they may share their real-time locations. Passenger A may also pay for the vehicle that passenger B takes. Step 205 may be performed by the output module 304 in the user maintenance system 101.

Obviously, for persons having ordinary skills in the art, multiple variations and modifications may be made under the teachings of the present disclosure. In some embodiments, the processor may include other modules or units. However, those variations and modifications should not depart from the scope of the present disclosure. For example, after the information is received in step 201, the operation in step 203 (determining the user stability) may be performed at first, and the operation in step 202 (determining the user value) may then be performed. It should be noted that the process for maintaining users described is merely for ease of understanding, not intended to be limiting the scope of the present disclosure. Each of steps may be performed by one module in the system or by several modules in the system. For example, the information received in step 201 may be received in step 202. In step 202, the user value may also be determined. Additionally, if the information received in step 201 has included the user value, the process may go to step 203 to determine the user stability or to step 205 to send the user value directly.

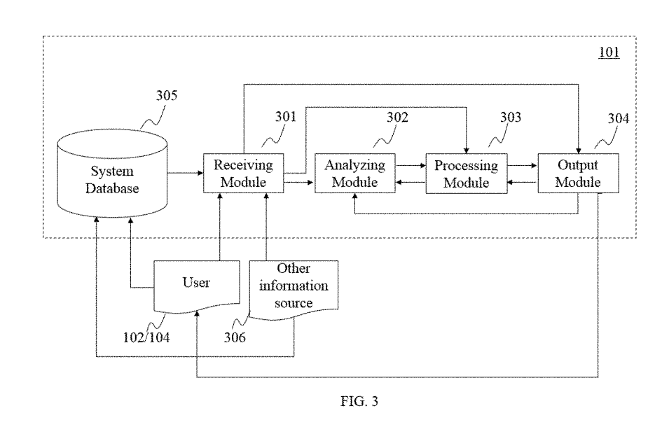

FIG. 3 is a block diagram of an exemplary user maintenance system according to some embodiments of the present disclosure. The user maintenance system 101 may include receiving modules 301, analyzing modules 302, processing modules 303, output modules 304, and system databases 305. One or more modules in the user maintenance system 101 may be connected to the network 105. The modules in the user maintenance system 101 may be centralized or distributed. One or more modules in the user maintenance system 101 may be local or remote. The receiving module 301 may receive information in any suitable manner. The information may be received directly (e.g., by acquiring information from one or more users 102/104 directly from the network 105) or indirectly (e.g., by receiving information through the receiving module 301, the analyzing module 302, the processing module 303, the output module 304, or the system database 305). The receiving module 301 may send a request to one or more users 102/104 and/or other information sources 306 to obtain information. Other information may include weather conditions, road conditions, traffic conditions, a ratio of the number of drivers to the number of passengers, a success rate of orders, or the like, or any combination thereof. The receiving module 301 may receive information through the network 105, and/or the database 103. The receiving module 301 may further process the received information or store the information in the system database 305 after receiving the information. The receiving module 301 may also send a request to the system database 305 to obtain the information stored in the system database 305. Alternatively, the system database 305 may send a request to the user 102/104 to obtain information and the information obtained may be stored in the system database 305. The user 102/104 may be a server or a communication terminal. Further, the server may include a web server, a file server, a database server, an FTP server, an application server, a proxy server, or the like, or any combination thereof. The communication terminal may include a phone, a personal computer, a wearable device, a tablet computer, a built-in device of a vehicle, a smart television, or the like, or any combination thereof. In some embodiments, the receiving module 301 may send the information received to the analyzing module 302 directly. In some embodiments, the receiving module 301 may send the information received to the processing module 303 directly. In some embodiments, the receiving module 301 may send the information received to the output module 304 directly. The analyzing module 302 may analyze information manually or automatically. The process of analyzing information may include feature extraction, feature processing, model selection, model updating, value determination, or the like, or any combination thereof. The analyzing module 302 may analyze order information, user information, or any other information to generate an order value, a user value or maintenance information. In some embodiments, the analyzing module 302 may send the analyzed information to the output module 304 directly. In some embodiments, the processing module 303 may receive the information from the analyzing module 302. The processing module 303 may process some related information. The processing module 303 may feedback the information processed to the analyzing module 302. The process of processing information may include model training, calculation, and analysis, model updating, friend classification, user identification, user maintenance, or the like, or any combination thereof. The output module 304 may output the information processed. The information output may include advertisements, statements, announcements, users shared information, user values, order values, user maintenance information, or the like, or any combination thereof. The information output may be sent to one or more users and/or a third-party platform or not. The information output that is not sent may be stored in the system database 305, the output module 304, or the database 103 through the network 105. The feedback of the related information may be sent to the analyzing module 302, the processing module 303, the system database 305, and/or any other database or storage devices.

The system database 305 may be a device that is capable of storing. The system database 305 may store information received from the user 102/104 and/or other information source 306, and may also store the information produced by the user maintenance system 101. The system database 305 may be local or remote. The connection or communication between the system database 305 and other modules in the system may be wired or wireless. The system database 305 or other storage devices may be media capable of reading/writing. The system database 305 or other storage devices may belong to the system or be a peripheral equipment of the system. The connection of the system database 305 or other storage devices in the system may be wired or wireless. The system database 305 or other storage devices in the system may include hierarchical databases, network databases, relational databases, or the like, or any combination thereof. The system database 305 or other storage devices in the system may digitize information and then store the information by taking advantage of electric energy, magnetic energy, or optical energy. The system database 305 or other storage devices in the system may include an electrical storage device, e.g., a variety of memories, a random access memory (RAM), a read-only memory (ROM), etc. The system database 305 or other storage devices in the system may include a magnetic storage device, e.g., a hard disk, a floppy disk, a magnetic tape, a magnetic core memory, a bubble memory, a USB flash drive, a flash memory, etc. The system database 305 and other storage devices in the system may include an optical storage device, e.g., CD or DVD. The system database 305 or other storage devices in the system may include may include a magnetic-optical storage device, e.g., a magnetic-optical disk (MO). The system database 305 or other storage devices in the system may store information randomly, serially, read-only, etc. The system database 305 or other storage devices in the system may be non-permanent or permanent memory. The storage devices described above are merely examples, and not intended to be limiting the scope of the present disclosure. The system database 305 or other storage devices in the system may be local, remote or on the cloud servers.

Obviously, to those skilled in the art, after understanding the basic principles of the user maintenance system and method, the form and details (e.g., the combination of individual modules, the connection between a sub-system and modules) may be modified or varied without departing from the principles. The modifications and variations are still within the scope of the current disclosure described above. For example, the receiving module 301, the analyzing module 302, the processing module 303, the output module 304 or the system database 305 may be different modules in the system. Alternatively, one of the modules may include the functions of two or more of the modules. For example, the analyzing module 302 may receive information and analyze the received information. As another example, the module may achieve the functions of the receiving module 301 and the analyzing module 302. Similar modifications are still within the scope of the present disclosure.

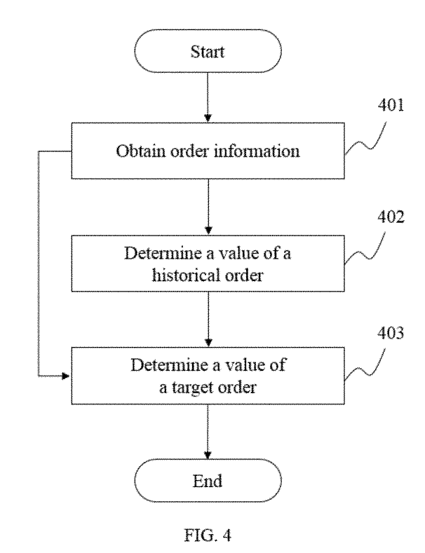

FIG. 4 is a flowchart of an exemplary process for determining an order value according to some embodiments of the present disclosure. In step 401, order information may be obtained. The order information may include information of historical orders (also referred to herein as “historical order information”), user information relating to the historical order information, information of a target order (also referred to herein as “target order information”), user information relating to the target order information, other information, or the like, or any combination thereof.

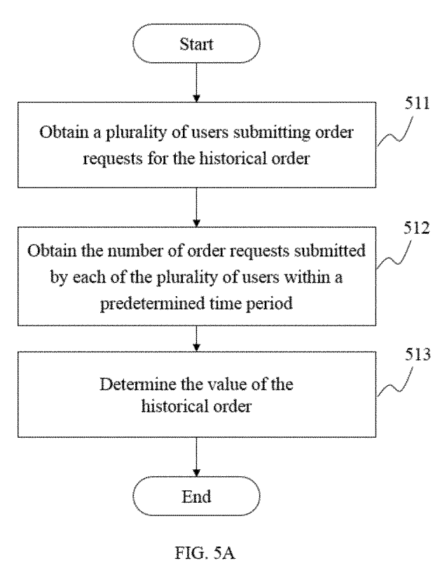

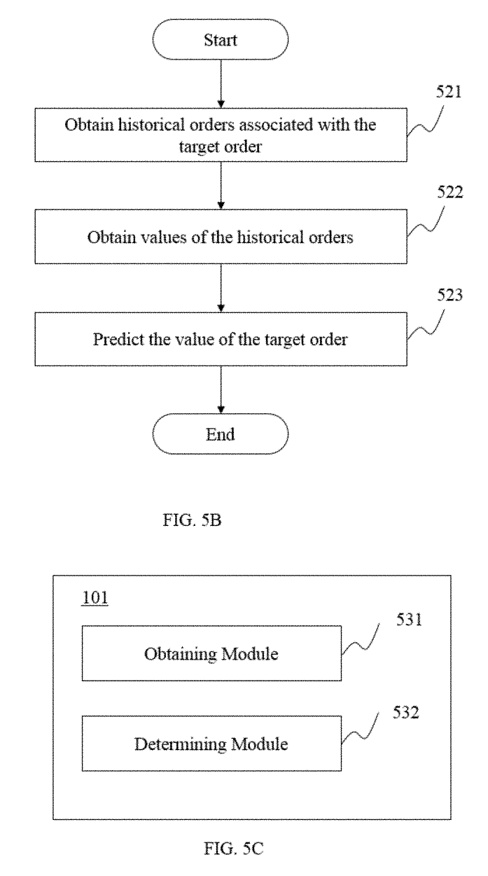

In step 402, the value(s) of historical order(s) (also referred to herein as “historical order values”) may be determined. In some embodiments, the historical order(s) may include a completed order, an uncompleted order, or the like, or any combination thereof. According to one embodiment of the present disclosure, the value(s) of historical order(s) may be determined based on the order information of the historical order(s). In another embodiment, the determination of the value(s) of the historical order(s) may be based on a model built according to the user information relating to the historical orders. In some embodiments, the processes described in connection with FIGS. 5A and 5B may be used to determine the value(s) of the historical order(s).

In step 403, a value of a target order (also referred to herein as a “target order value”) may be determined. In some embodiments, the target order may include a real-time new order, a reservation new order, or the like, or any combination thereof. In some embodiments, the target order value may be determined based on the value(s) of one or more historical orders relating to the target order. In some embodiments, the target order value may be determined based on a model built according to features relating to the order value.

It should be noted that the above description about the user value is merely an example, and not intended to be limiting the scope of the present disclosure. For those skilled in the art, after understanding the basic principles of the present disclosure, the form and details of the process of determining an order value may be modified or varied without departing from the principles. For example, to the built model, the model may include a mathematical model or a physical model. The mathematical model may include an algebraic equation, a differential equation, a difference equation, an integral equation, a statistical equation, or the like, or any combination thereof. The physical model may include an analog model. The analog model may be a model that is built based on a common rule obeyed by some variables in a system of different physical area (e.g., mechanics, electrics, thermionics, fluid mechanics, etc.), wherein the model with the same or similar or absolutely different physical means may be obtained through comparing and analogizing.

FIG. 5A is a flowchart of an exemplary process for determining a historical order value according to some embodiments of the present disclosure. In step 511, the system may obtain a plurality of users that submit order requests (service requests) for a historical order. In some embodiments, the users may be drivers. When a passenger publishes the historical order, the plurality of users may submit order requests for the historical order via a “striving” function. In some embodiments, only one of the users may obtain the historical order and may provide a service to the passenger to complete the historical order. In some embodiments, instead of only analyzing information about the user that provides the service to the passenger, the system may analyze information on several or all of the plurality of users to accurately determine the value of the historical order based on degrees of the attraction of the historical order to the plurality of users.

In step 512, the number of order requests submitted by each of the plurality of users within a predetermined time period may be obtained. Because of differences among the plurality of users, when the plurality of users submits an order request, they may obey different criteria. For example, some users may obtain orders through striving for lots of orders, especially in the morning peak hours and the evening peak hours. In addition, additional rewards may be more in these time periods, so the users may strive for any order without considering the cost performance of the order. Therefore, during the process of determining the historical order value, to avoid the situation that the order value is falsely high because of striving, the number of the order requests submitted by each of the plurality of users within a predetermined time period (e.g., every day) may be considered, which may be helpful to accurately determine the historical order value based on degrees of attraction of the history order to the plurality of users.

In step 513, the historical order value may be determined based on the number of order requests submitted by each user. In some embodiments, the historical order value may be determined based on the reciprocal of the number of order requests submitted by each user. In some embodiments, the historical order value may be determined by adjusting a weight of each user based on a comparative result between the number of order requests submitted by each user and a predetermined threshold.

For a better understanding of the present disclosure, a detailed description about step 513 may be provided. According to some embodiments of the present disclosure, the order value of the historical orders may be determined based on the sum of the reciprocal of the number of the order requests submitted by each user. For instance, to obtain the historical order value, a plurality of users that strives for the historical order may be obtained first. Assuming that a plurality of users that strives for the historical order include USER 1, USER 2, and USER 3, the historical order value for each of the users (also referred to herein as the “value for user”) may be obtained. For instance, assuming that the total number of the orders that USER 1 strived for in the day when the historical order is published is 50, then, the historical order value for USER 1 may be 1/50. Similarly, assuming that the total numbers of the orders strived by USER 2 and USER 3 in the day when the historical order is published are 100 and 200, respectively, the historical order value for USER 2 and the historical order value for USER 3 may be 1/100 and 1/200, respectively. Therefore, the historical order value may be determined by the sum of the values for USER 1, USER 2, and USER 3, which is 7/200. In some embodiments, for the historical order described above, the credit values of USER 1, USER 2, and USER 3 may be obtained. The credit values may be obtained based on the number of completed orders for USER 1, USER 2, and USER 3. The credit values may also be determined in advance based on the working years and the scores of USER 1, USER 2, and USER 3. Then, the historical order value may be determined based on the sum of the products of the value for each user (USER 1, USER 2, and USER 3) and the corresponding credit value.

In some embodiments, the time interval between the time when a passenger publishes the historical order and the time when each of the plurality of users submits the order request for the historical order may also be used to determine the historical order value. In some embodiments, the shorter the time interval is, the more important and valuable the order may be for some users. Thus, to determine the historical order value more accurately, the value of the historical order may be determined as the sum of the products of the value for each user (USER 1, USER 2, and USER 3) and the reciprocal of the corresponding time interval.

In some embodiments, a ratio of the number of the plurality of users to the number of users on-line when publishing the historical order (also referred to as the “user ratio”) may also be used to determine the value of the historical order. For different time intervals, the number of users on-line may be different or the same. For instance, the number of users on-line in the morning and/or evening peak hours may be higher than the number of users on-line deep in the night. Thus, to determine the value of historical order more accurately, the value of the historical order may be determined as the sum of the products of the value for each user (USER 1, USER 2, and USER 3) and the reciprocal of the corresponding user ratio.

According to some embodiments of the present disclosure, the system for determining the value of historical orders may include the receiving module and the analyzing module in the user maintenance system shown in FIG. 3. For the convenient discussion, the system may be described with reference to the user maintenance system 101 shown in FIG. 3. The receiving module 301 in FIG. 3 may be the same as and/or similar to the obtaining module 531 and the analyzing module 302 in FIG. 3 may be the same as and/or similar to the determining module 532. The system may include a first obtaining sub-module and a second obtaining sub-module of the obtaining module 531. The system may further include a first determining sub-module of the determining module 532. In some embodiments, the first obtaining sub-module may obtain the plurality of users submitting the order requests for the historical order. The second obtaining sub-module may obtain the number of the order requests submitted by each user among the plurality of users within the predetermined time period. The first determining sub-module may determine the value of the historical order based on the number of the order requests submitted by each user.

According to another embodiment of the present disclosure, the first determining sub-module, including a first determination unit, may determine the value of the historical order based on the reciprocal of the number of the order requests submitted by each user. As another example, the first determining sub-module, including a second determining unit, may determine the value of the historical order based on the sum of the reciprocals of the number of the order requests submitted by each user. According to another embodiment of the present disclosure, the first obtaining sub-module, including a first obtaining unit, may obtain a time interval between the time when the passenger publishes the historical order and the time when each of the plurality of user submits the order request for the historical order. The first determining sub-module, including a third determining unit, may determine the value of the historical order based on the sum of the reciprocals of the time interval multiplied by the number of the order requests submitted by each user. According to another embodiment of the present disclosure, the first obtaining sub-module, including a second obtaining unit, may obtain the credit value of each user among the plurality of users. The first determining sub-module, including a fourth determining unit, may determine the value of the historical order based on the sum of the quotients of the credit value and the number of the order requests submitted by each user. According to another embodiment of the present disclosure, the first obtaining sub-module, including a third obtaining unit, may acquire the ratio of the number of the plurality of users and the number of the users on-line when publishing the historical order. The first determining sub-module, including a fifth determining unit, may determine the value of the historical order based on the sum of the quotients of the ratio and the number of the order requests submitted by each user.

It should be noted that the above description of the system for determining the user value is merely an example, and not intended to be limiting the scope of the present disclosure. For those skilled in the art, after understanding the basic principles of the present disclosure, the form and details of the process of determining the user value may be modified or varied without departing from the principles. For example, the sub-modules of the obtaining module may be integrated into one single integrated circuit module. The sub-modules of the determining module may be integrated into one single integrated circuit module.

According to some embodiments of the present disclosure, FIG. 5B shows a process of determining a value of a target order (also referred to herein as a “target order value”). In step 521, one or more historical orders corresponding to the target order may be obtained. In some embodiments, the historical order(s) may be obtained based on the starting location and the destination location of the target order. For the problem described in the background of the application, the embodiments of the present disclosure may concentrate more on the starting location and the destination location, thereby avoiding to determine an order with a remote destination location as a high-value order. In some embodiments, the historical order(s) may be obtained based on a time period in which the passenger published the target order. For instance, most of the users living in the suburbs may choose to complete a remote order on the way to home. Therefore, part of the orders with a remote destination location may have a higher value. Therefore, the values of the historical orders obtained in the time period may be used to determine the target order value more accurately. In step 522, the values of the historical orders may be obtained.

In step 523, based on the values of the historical orders, the value of the target order may be determined. The value of the target order may be obtained based on one or more historical orders values. As one example, the value of the target order may be determined based on the average value or weighted average value of the historical order values. The value of the target order may also be determined based on other numerical values suitable to represent the value of the target order. As another example, the value of the target order may be determined by a value of a certain historical order. For instance, the value of the target order may include a median value of the values of the plurality of historical orders, a maximum value or a minimum value of the historical order values in a certain time interval or the value of other historical order suitable to represent the value of the target order.

It should be noted that the above description of the process of determining the user value is merely an example, and not intended to be limiting the scope of the present disclosure. For those skilled in the art, after understanding the basic principles of the present disclosure, the form and details of the process of determining the user value may be modified or varied without departing from the principles. In some embodiments, the historical orders associated with the target order and the values of the historical orders may be obtained at the same time to determine the target order value. In some embodiments, the target order value may be determined based on a model built according to the features relating to the order value. The target order value may be determined based on the weighted average value of the historical order values. The target order value may also be determined based on an order value added by the user.

According to some embodiments of the present disclosure, the system for determining the target order value may include the receiving module 301 and the analyzing module 302 of the user maintenance system 101 described in FIG. 3. FIG. 5C is a block diagram of a system for determining the order value according to some embodiments of the present disclosure. For illustration, the system may be described with reference to the user maintenance system 101 described in FIG. 3. The receiving module 301 in FIG. 3 may be the same as and/or similar to the acquisition module 531. The analyzing module 302 in FIG. 3 may be the same as and/or similar to the determining module 532. The system may include a third obtaining sub-module and a fourth obtaining sub-module of the obtaining module 531. The system may further include a second determining sub-module of the determining module 532. The third obtaining sub-module may obtain the historical orders associated with the target order. The fourth obtaining sub-module may obtain the values of the historical orders. The fourth obtaining sub-module may also determine the values of the historical orders based on the respective number of the order requests submitted by each user among the plurality of users within the predetermined time period. The second determining sub-module may determine the target order value based on the values of the historical orders.

According to some embodiments of the present disclosure, the value of the historical order may be determined based on the reciprocal of the number of the order requests submitted by each user. As one example, the value of the historical order may be determined based on the sum of the reciprocals of the number of the order requests submitted by each user. As another example, the value of the historical order may be determined based on the sum of the reciprocals of the time interval multiplied by the number of the order requests submitted by each user. In some embodiments, the value of the historical order may be determined based on the quotients of a ratio and the number of the order requests submitted by each user. The ratio may be a ratio of the number of the multiple users and the number of the users on-line when publishing the historical order. In some embodiments, the third obtaining sub-module, including a fourth obtaining unit, may obtain the historical orders based on the starting location and the destination of the target order. In some embodiments, the second determining sub-module, including a sixth determining unit, may determine the target order value based on the average value of the values of the historical orders.

It should be noted that the above description of the process of determining the user value is merely an example, and not intended to be limiting the scope of the present disclosure. For those skilled in the art, after understanding the basic principles of the present disclosure, the form and details of the process of determining the user value may be modified or varied without departing from the principles. For example, the modules or steps described in the application may be implemented by some general computing devices. In some embodiments, the modules may be in one general computing device. In some embodiments, the modules may be distributed in a network formed by a plurality a computing device. In some embodiments, the steps may be implemented as computer-readable instructions. The instructions may be stored in a storage device to be performed. The instructions may also be integrated into integrated circuit modules, respectively. The applications are not limited to the combination of certain hardware or software, which is merely an example, not intended to be limiting the scope of the present disclosure. For persons having ordinary skills in the art, multiple variations and modifications may be made under the teachings of the present disclosure. However, those variations and modifications do not depart from the scope of the present disclosure.

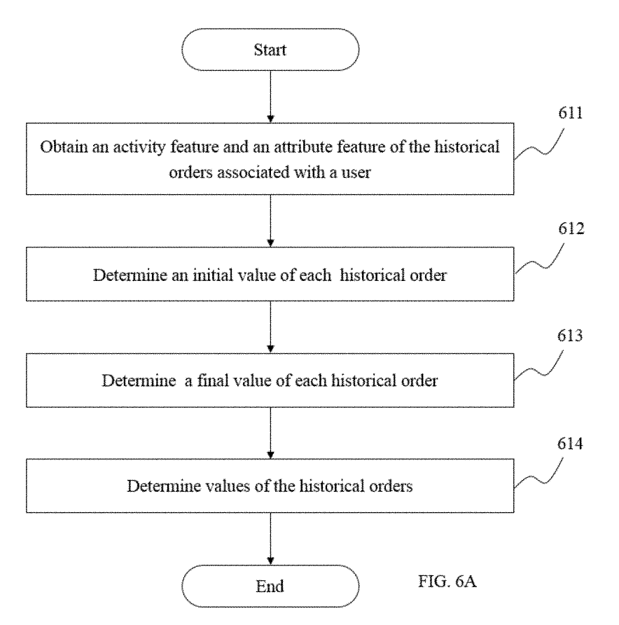

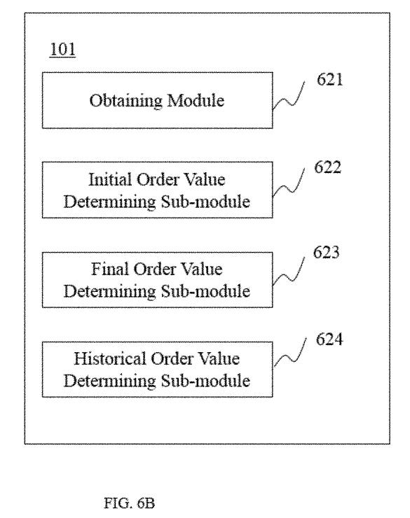

FIG. 6A is a flowchart showing the process of determining the historical order value according to some embodiments of the present disclosure. In step 611, activity features and attribute features of all of the historical orders may be obtained. The activity features may include, but are not limited to, the number of orders placed by the users, the shortest time to strive for an order by a driver, the number of striving for one or more orders, or the like, or any combination thereof. The attribute features may include, but are not limited to, the state that whether an order is strived successfully, the platform benefit, an order distance, an order cost, the number of days from the time when the order happens, or the like, or any combination thereof. In step 612, an initial value of each historical order may be determined based on the activity features obtained in step 611. In step 613, a final value of each historical order may be determined based on the initial value of the corresponding order and the one or more attribute features. In step 614, the historical order value may be determined based on the final value of each order.

For a better understanding of the present disclosure, a detailed description about step 611 may be provided. In some embodiments, step 611 may include generating a corresponding table for each historical order, such as a hive table. Step 611 may further include generating a summary table by combining the hive tables corresponding to all of the historical orders. Step 611 may also include obtaining activity features and attribute features of the historical orders. It should be noted that the summary table may lack some attribute features (also referred to herein as “missing attribute features”). Therefore, it may be needed to complete the missing attribute features based on information relating to the historical orders. The information relating to the historical orders may include, but is not limited to, a starting location, a destination location, a starting time, an arrival time, a travel trajectory, or the like, or any combination thereof. As one example, because of a speech input or omission by the system, part of orders may lack a destination location, so the system may determine the destination location based on the trajectory of a driver or the location where a passenger pays for the order. A missing order distance (e.g., a Manhattan distance) may be determined based on the starting location and the determined destination location. As another example, since some orders may not be paid using WeChat, the order cost may not be obtained. Therefore, the system may determine the order cost based on the corresponding starting location, the corresponding destination location, and the corresponding starting time. In some embodiments, when a user publishes an order unsuccessfully at the first time, he/she may publish the order repeatedly. In this case, step 611 may include an operation of deduplication regarding the orders that include the same content.

For a better understanding of the present disclosure, a detailed description about step 612 may be provided. In some embodiments, step 612 may include smoothing activity features with a greater weight, so that the activity features with a greater weight may not heavily impact the initial value of each order. The smoothing operation may include using a logarithmic processing, for example, a base-2 logarithmic processing. Step 612 may further include determining the initial value of each order based on the smoothed activity features. A specific example may be described in detail with respect to step 612 and the following steps. For example, a user published two orders in a past time period. The first order is successful (feature-1 is 1), wherein there are two drivers that strive for the first order (feature-2 is 2). The striving time is 10 seconds (feature-3 is 10), the platform benefit is 50 “dimi” (feature-4 is 50). The order distance is 12 kilometers (feature-4 is 12). The order cost is 30 yuan (feature-4 is 30). The tip provided by the user is 5 yuan (feature-7 is 5). The number of days from the time when the order happens is 5 (feature-8 is 5). The second order is not successful, wherein the user published the second order three times (feature-1 is 3), but there is no driver to receive the second order (feature-2 is 0). The benefit provided by the platform is 100 “dimi” (feature-4 is −100). The order distance is 5 kilometers (feature-5 is 5). The order cost is 20 yuan (feature-6 is 20). There is no tip provided by the user (feature-7 is 0). The number of days from the time when the order happens is 15 (feature-8 is 15). For clarity, the following table shows part of features relating to the two orders.

TABLE 1
part of features relating to the two orders of a user in a past time period

| | | | Feature-3 | Feature-4 | Feature-5 | Feature-6 | Feature-7 | |
|---|---|---|---|---|---|---|---|---|
| Order | Feature-1 | Feature-2 | (second) | (dimi) | (kilometer) | (yuan) | (yuan) | Feature-8 |
| 1 | 1 | 2 | 10 | 50 | 12 | 30 | 5 | 5 |
| 2 | 3 | 0 | / | −100 | 5 | 20 | 0 | 15 |

In step 612, the activity features obtained in step 611 may be adjusted. More particularly, for the first order, the striving time is adjusted to the shortest time to make a deal that is 18 seconds. The number of drivers striving for an order is limited to at most 30, and the case that there are more drivers to strive for an order is no longer to be distinguished. The initial value of the first order (Vᵢ₁) may be obtained based on Equation 1:

Vᵢ₁=log₂(T)×log₂(N+1), (Equation 1)

wherein “T” may represent the striving time; and “N” may represent the number of drivers striving for the order. For the first order, because the striving time has been adjusted to the shortest time to make a deal that is 18 seconds, and the number of drivers striving for the order is 2 (N=2), the initial value of the first order may be that Vᵢ₁=4.170×1.585=6.61. For the second order, because the second order is not successful, and the user published the second order for several times, the initial value of the second order (Vᵢ₂) may be negative. The initial value of the second order may be obtain based on Equation 2:

Vᵢ₂=−log₂(R+1), (Equation 2)

wherein “R” may represent the number of orders placed by the user. For the second order, because the user placed three orders (R=3), the initial value of the second order may be that Vᵢ₂=−log₂(3+1)=−2. It should be noted that, for the above two equations and part of the equations in the following, it may need to add a constant to some attribute features to avoid that the initial value of an order is zero.

For a better understanding of the present disclosure, a detailed description about step 613 may be provided. In some embodiments, step 613 may include weighting the one or more attribute features, and smoothing the attribute features with a greater weight, so that the attribute features associated with a greater weight may not heavily impact the final value of each order. The smoothing operation may include using a logarithmic processing, for example, a base-2 logarithmic processing. Step 613 may further include determining the final value of each order based on the initial value and the smoothed attribute features. Based on the attribute features, the initial value of each order obtained in step 612 may be adjusted as follows: first, determining a first adjusted weight parameter by adjusting the order value based on the order distance and the order cost. To avoid that the final value of the order is heavily impacted by the order distance and the order cost, a base-2 logarithmic processing may be used so that the final value of the order may smoothly (or mildly) rise with the order distance and the order cost. More particularly, the adjusted weight parameter (P₁₁) of the first order may be obtained based on Equation 3:

P₁₁=log₂((D/D₀)+1)×log₂((C/C₀)+1), (Equation 3)

wherein “D” may represent the order distance; “Do” may represent an order distance per unit (or the shortest order distance); “C” may represent the order cost; and “C₀” may represent an average cost of orders of all users. It should be noted that the adjusted weight parameter may be denoted as “Pₘₙ,” wherein “m” may represent the number of the adjusted weight parameters, and “n” may represent the number of the orders (both m and n are integers larger than 1). In this example, the order distance per unit (D₀) is 10 kilometers, and the average order cost of all users (C₀) is 20 yuan. Thus, with reference to parameters (feature-n) of the first order (e.g., D=20, and C=30) the first adjusted weight parameter of the first order may be P₁₁=log₂((12/10)+1)×log₂ ((30/20)+1)=1.137×1.322=1.50. For the second order, because the order is not successful, the attribute features such as the order distance and the order cost are unknown, and the first adjusted weight parameter of the second order (P₁₂) may be unknown either (in this case, P₁₂ does not exist). Then a second adjusted weight parameter may be obtained based on that whether an order is successful. Specially, if the order is successful, as long as a cost provided by the platform (e.g., an added cost, the number of “dimi,” a red packet, vouchers, or other platform subsidies) is not too high, the value of the order may be positive. On the contrary, the value of the order may be negative based on the cost provided by the platform. As referred to herein, the term “dimi” may refer to a reward that is determined based on the analysis of big data. In some embodiments, “dimi” is presented in the form of a virtual point in the driver terminal. In some embodiments, for a high-quality order (an order with longer travel distance and/or better road condition), the corresponding driver may need to provide some “dimi” to the system, or the system may deduct “dimi” from the driver's account. Similarly, for a low quality order (an order with shorter travel distance and/or worse road condition), the corresponding driver may gain some “dimi” from the system.

If an order is not successful, with the increase of cost provided by the platform, a negative value may become greater. For example, for the first order, the platform benefit is 50 “dimi” (a positive benefit). Therefore, the second adjusted weight parameter of the first order (P₂₁) may be obtain based on Equation 4:

P₂₁=1+G/100, (Equation 4)

wherein “G” may represent the platform benefit, and the constant “100” may be used to normalize the positive platform benefit. In this example, for the first order, G=50, then, P₂₁=1+50/100=1.5. For the second order, though the user published the second order for several times and the platform provided 100 “dimi,” there is still no driver to accept the second order. It may seem that the value of the second order is very low, and there may be a positive effect. Therefore, the second adjusted weight parameter of the second order (P₂₂) may be obtained based on Equation 5:

P₂₂=G/V₀, (Equation 5)

wherein “G” may represent the platform benefit; and “V₀” may represent a value of “dimi” per unit (the smallest value of “dimi”). In some embodiments of the present disclosure, the value of “dimi” per unit may be used to normalize a negative benefit. In the example, the value of “dimi” per unit may be set as a constant “50”, and G=−100. Therefore, the second adjusted weight parameter of the second order may be P₂₂=−100/50=−2. Then, a third adjusted weight parameter may be obtained based on the number of days from the time when the order was published. In order to response quickly to the user state recently. The third adjusted weight parameter (P₃ₙ) may be obtain based on Equation 6:

P₃ₙ=1−d/H, (Equation 6)

wherein “n” may represent the number of an order; “d” may represent the number of days from the time when the order was published; and “H” may represent the number of historic days. In some embodiments, the number of historical days may be 150, which may mean that orders in the past 150 days are used. More particularly, for the first order, the number of days from the time when the first order was published is 5. As a result, the third adjusted weight parameter of the first order may be P₃₁=1−5/150=0.967. For the second order, the number of days from the time when the second order was published is 15. As a result, the third adjusted weight parameter of the first order may be P₃₂=1−15/150=0.9. At last, based on all of the adjusted weight parameters (Pₘₙ), the final value of each order may be determined by adjusting the initial value of each order obtained in step 612. More particularly, the final value of the first order may be obtained based on Equation 7:

V_{f1}=Vᵢ₁×P₁₁+P₂₁×P₃₁. (Equation 7)

In this example, V_{f1}=6.61×1.5×1.5×0.967=14.38, and since the first order is successful and the platform benefit is positive, the first order may be determined as a good order. The final value of the second order may be obtained based on Equation 8:

V_{f2}=(Vᵢ₂+P₂₂)×P₃₂. (Equation 8)

In this example, V_{f2}=(−2−2)×0.9=−3.6, and since the second order is not successful and cost the resource of the platform (e.g., the platform provides 100 “dimi”), the second order may be determined as a very poor order.

For a better understanding of the present disclosure, a detailed description about step 614 may be provided. In some embodiments, step 614 may include summing the final values of all orders to generate a sum value. Step 614 may further include determining one or more quality factors and consumption factors of all historical orders. Step 614 may also include determining the historical order value(s) of the user based on the sum value, the quality factors and the consumption factors. In some embodiments, the quality factors may be determined based on the order levels. The consumption factor may be determined based on an average order cost of the user, an amount of a tip, a ratio of the number of tips provided to the total number of orders, a sum of amount of platform subsidies used (e.g., red packets, “dimi,” or vouchers), or a ratio of the amount of platform subsidy to the order cost. The order levels may include, but are not limited to, “very good,” “good,” “normal,” “poor,” and “very poor.” The specific example described above may also be used for step 614. First, summing the final values of all orders to generate the sum value, represented as “Sum,” based on Equation 9:

Sum=V_{f1}+V_{f2}+ . . . +V_{fn}. (Equation 9)

Thus, in this example, Sum=V_{f1}+V_{f2}=14.38+(−3.6)=10.78. The quality factor (Q) may be determined based on the order levels, and the quality factor may be obtained based on Equation 10:

Q=1+(L_{A}/Tot)×0.9, (Equation 10)

wherein “L_{A}” may represent a factor of the average order level; and “Tot” may represent the total number of orders. Since the first order is a good order and the second order is a very poor order, the combination of the two orders may be determined as a poor order. In some embodiments, each average order level may correspond to a factor of the average order level. In this example, the average order level is poor, and the corresponding factor of the average order level is “−1.” Therefore, the quality factor may be Q=1+(−1/2) 0.9=0.55. Then, in step 614, the consumption factor may be determined based on an average order cost of all users, an amount of a tip, a ratio of the number of times providing tips to the total number of orders, a sum amount of platform subsidies used (e.g., red packets, “dimi,” or vouchers), or a ratio of the sum amount of platform subsidies to the order cost. The first consumption factor (S₁), determined by the average order cost of the user, may be obtained based on Equation 11:

S₁=log₂(C_{A}/C₀+2), (Equation 11)

wherein “C_{A}” is the average order cost of the user; and “C₀” is the average order cost of all users. Since the average order cost of the user is 25 yuan and the average order cost of all users is 20 yuan, the first consumption factor may be S₁=log₂ (25/20+2)=1.7. The second consumption factor (S₂), determined by the amount of tip provided by the user and the corresponding ratio, may be obtained based on Equation 12:

S₂=1+log₂(Nₜ/Tot+2)×log₂(t_{A}+2)×log₂(Tot/10+1), (Equation 12)

wherein “Nₜ” may represent the number of times providing tips; “Tot” may represent the total number of orders; and “t_{A}” may represent an average amount of tips. Since in the above two orders, the user provides one tip (the amount of the tip is 5 yuan), the average amount of tips may be 2.5. Therefore, the second consumption factor may be S₂=1+log₂ (2.5)×log₂ (4.5)×log₂ (1.2)=1.754. Then the historical order value, determined by the final values of all orders, the quality factors and the consumption factors, may be obtained based on Equation 13:

V_{H}=Sum×Q×(S₁×S₂ . . . ×S_{N}) (Equation 13)

wherein “N” may represent an integer greater than 1. In this example, the historical order value of the user may be V_{H}=10.78×0.55×1.7×1.754=17.68.

It should be noted that the above description of the process of determining the user value (as shown in step 202) is merely an example. For those skilled in the art, the method of determining the historical order value may further include the method of determining a target order value, which has been described with reference to FIG. 5B in detail, and will not be described again.

According to some embodiments of the present disclosure, the system for determining the historical order value may include the receiving module and the analyzing module of the user maintenance system 101 described in FIG. 3. FIG. 6B is a block diagram of a system for determining the historical order value according to some embodiments of the present disclosure. For the purposes of illustration, the system may be described with reference to the user maintenance system 101 described in FIG. 3. The receiving module 301 in FIG. 3 may be the same as and/or similar to the obtaining module 621 and the analysis module 302 in FIG. 3 may be the same as and/or similar to the determining module 622, 623, and/or 624. The system may include the obtaining module 621 and the determining module including the initial order value determining sub-module 622, the final order value determining sub-module 623, and the historical order value determining sub-module 624. The obtaining module 621 may obtain the activity features and the attribute features of all the historical orders. The initial order value determining sub-module 622 may determine an initial value of each order based on the activity features. The final order value determining sub-module 623 may determine the final value of each order based on the initial value of each order and the attribute features. The historical order value determining sub-module 624 may determine the historical order value(s) of the user based on the final value of each order of the user.

In some embodiments, the activity feature may include, but is not limited to, the number of orders placed by users, the shortest time to strive for an order by a driver, the number of times striving for orders, or the like, or any combination thereof. The attribute feature may include, but is not limited to, the state that whether an order is strived successfully, the platform benefit, the order distance, the order cost, the number of days from the time when the order happens, or the like, or any combination thereof. In some embodiments, the obtaining module may include, but is not limited to, a table generating unit, a summary table generating unit, a feature extracting unit, an attribute feature completing unit. The table generating unit may generate a corresponding table for each historical order. The summary table generating unit may generate a summary table for all the historical orders. The feature extracting unit may extract the activity features and the attribute features of all the historical orders from the summary table. The feature completing unit may complete the missing attribute features in the summary table to obtain the attribute features of all the historical orders. In some embodiments, the missing attribute features may include the order distance and the order cost. In some embodiments, the feature completing unit may include, but is not limited to, an order distance determining subunit and an order cost determining subunit. The order distance determining subunit may determine the order distance based on the travel trajectory, the starting location, and/or the destination location. The order cost determining subunit may determine the order cost based on the starting location, the destination location, and/or the starting time of the order. In some embodiments, the initial order value determining sub-module may include, but is not limited to, an activity feature processing unit and an initial order value determining unit. The activity feature processing unit may smooth the activity features associated with a greater weight. The initial order value determining unit may determine the initial value of each order based on the smoothed activity features. In some embodiments, the final order value determining sub-module may include, but is not limited to, an attribute feature processing unit and a final order value determining unit. The attribute feature processing unit may smooth the attribute features associated with a greater weight. The final order value determining unit may determine the final value of each order based on the initial value of each order and the smoothed attribute features. In some embodiments, the historical order value determining sub-module may include, but is not limited to, a summing unit, a factor determining unit, and a historical order value determining unit. The sum unit may sum the final values of all orders to generate the sum value. The factor determining unit may determine the quality factors and the consumption factors of all the historical orders. The historical order value determining unit may determine the historical order value based on the sum value, the quality factors and the consumption factors.

It should be noted that the above description of the process of determining the user value is merely an example, and not intended to be limiting the scope of the present disclosure. For those skilled in the art, after understanding the basic principles of the present disclosure, the form and details of the process of determining the user value may be modified or varied without departing from the principles. For example, the modules or steps described in the application may be implemented by some general computing devices. In some embodiments, the modules may be in one general computing device. In some embodiments, the modules may be distributed in a network formed by a plurality a computing device. In some embodiments, steps may be implemented as computer-readable instructions. The instructions may be stored in a storage device to be performed. The instructions may also be integrated into integrated circuit modules, respectively. The application is not limited to the combination of some certain hardware or software, which is merely an example, not intended to be limiting the scope of the present disclosure. For persons having ordinary skills in the art, multiple variations and modifications may be made under the teachings of the present disclosure. However, those variations and modifications do not depart from the scope of the present disclosure.

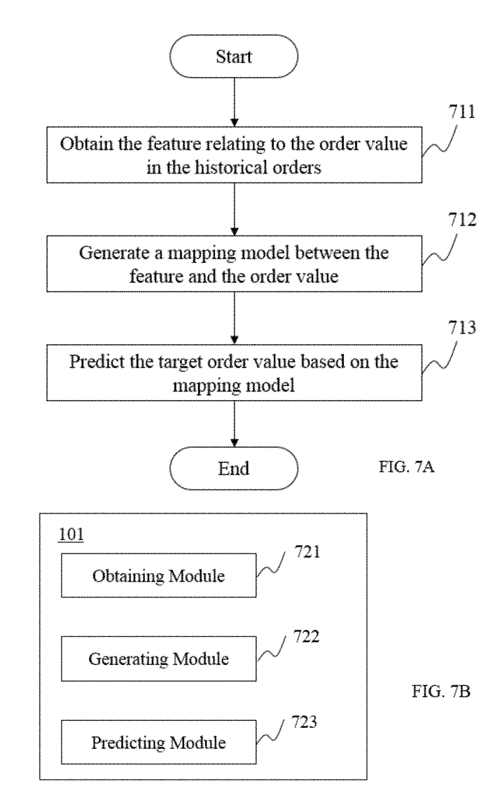

FIG. 7A is a flowchart of an exemplary process for predicting the order value according to some embodiments of the disclosure. As shown in FIG. 7A, in step 711, one or more order features associated with an order value of the historical orders may be obtained. In step 712, a mapping model between the features and order values may be generated. Further, in step 713, a value of a target order may be predicted based on the mapping model and the data of the target order. As one example, the order value may include information of mileage and price. In the existing taxi platform system, due to the increasing number of users, the taxi platform system has accumulated a great amount of order information. The order information may include, but is not limited to, a starting location, a destination location, a starting time, a mileage, a price, or any other information. Therefore, the taxi platform system may obtain the data of historical orders to establish a mathematical model.

For a better understanding of the present disclosure, a detailed description about step 711 may be provided. According to some embodiments of the present disclosure, the features associated with the order value may include, but are not limited to, a longitude of a starting location, a latitude of the starting location, a longitude of a destination location, a latitude of the destination location, a starting time, or the like, or any combination thereof. The set of the features may be expressed as Equation 14:

Oᵢ={sxᵢ,syᵢ,exᵢ,eyᵢ,tᵢ}, (Equation 14)

wherein i=1, 2, 3, . . . n; “Oᵢ” may represent the set of features of the ith order; “sx” may represent the longitude of the starting location; “sy” may represent the latitude of the starting location; ex may represent the longitude of the destination location; “ey” may represent the latitude of the destination location; and “t” may represent the starting time of the order. In step 711, the mapping model between the features and the order values may be built after obtaining a large number of the order features. For example, the mapping relationship {Dᵢ, Oᵢ} between the mileage of the order and the features of the order may be built, and the mapping relationship {Pᵢ, Oᵢ} between the order price and the features of the order may be established, wherein, “Dᵢ” may represent the mileage of the ith order, “Pᵢ” may represent the price of the ith order, and “Oᵢ” may represent the features of the ith order. Moreover, the mapping model may be updated using the data of the target order. In some embodiments, the processing of the historical data by steps 711 and 712 may be done off-line.

To facilitate understanding of the present disclosure, step 713 is described in detail below. According to some embodiments of the present disclosure, the taxi platform system need to predict the target order value after inputting the target order to the taxi platform system. The predicting of the value of the target order based on the mapping model and the data of the target order may include, but is not limited to, extracting the one or more features of the target order associated with the order value; and determining the value of the target order based on the features of the target order and the mapping model. As one example, the extracted features of the target order sent by the user may be expressed as Equation 15:

Oₚ={sxₚ,syₚ,exₚ,eyₚ,tₚ}, (Equation 15)

wherein “Oₚ” may represent the feature set of the target order; “sx” may represent the longitude of the starting location of the target order; “sy” may represent the latitude of the starting location of the target order; “ex” may represent the longitude of the destination location of the target order; “ey” may represent the latitude of the destination location of the target order; and “t” may represent the starting time of the target order. In one embodiment, the process of predicting the value of the target order based on the mapping model and the data of the target order may include, but is not limited to, determining the value of the target order as the average value of the values of the historical orders associated with the target order. For example, the mileage (Dₚ) may be expressed as Equation 16 and the price (Pₚ) of the target order may be expressed as Equation 17:

$$\begin{matrix}{D}_{P} = \frac{1}{M} {\sum }_{j = 1}^{M} ρ ( {O}_{p} , {O}_{j} ) {D}_{j} , & ( Equation 16 ) \\ {P}_{p} = \frac{1}{M} {\sum }_{j = 1}^{M} ρ ( {O}_{p} , {O}_{j} ) {P}_{j} , & ( Equation 17 ) \\ ρ ( {O}_{p} , {O}_{j} ) = \{ \begin{matrix}1 , & ω ( {O}_{p} , {O}_{j} ) \leq W \\ 0 , & ω ( {O}_{p} , {O}_{j} ) > W\end{matrix} , & ( Equation 18 )\end{matrix}$$

wherein “D_{P}” may represent the mileage of the target order; “Pₚ” may represent the price of target order; “Oₚ” may represent the features of the target order; “Dⱼ” may represent the mileage of the jth order; “Pⱼ” may represent the price of the jth order; ω(Oₚ, Oⱼ) may represent a metric distance, wherein the metric distance may include a Mahalanobis distance and a Euclidean distance, and “W” is a constant value. The Euclidean distance may be defined as the distance normally used and refers to the true distance between two points in an m-dimensional space, or the natural length of a vector (e.g., the distance from the point to the origin point). The Euclidean distance in a 2-dimensional and/or 3-dimensional space may refer to the true distance between two points. The Mahalanobis distance may be the covariance distance of data. It may be an effective method to calculate the similarity between two unknown sample sets. Unlike the Euclidean distance, the Mahalanobis distance takes care of the relationship between various features (e.g., the starting location of an order may include information about the time, since they are related to each other). The Mahalanobis distance is scale-invariant (i.e., it is independent of the measurement scale.). As shown in Equation 18, when the metric distance between the feature of the target order and the feature of a historical order is less than a preset threshold, it may be determined that the historical order is associated with the target order. The value of the target order may be determined based on the associated historical orders. The value of W in Equation 18 may be set based on a Gaussian distribution, for example, based on the value of a data corresponding to the maximum probability distribution of the Mahalanobis distance or Euclidean distance. Based on Equation 16 to Equation 18, in this embodiment, the order data associated with the target order has a value of 1, and the mileage (travel distance) and the price of the target order may be determined to be the average value of mileage and price of the historical orders, respectively. In some cases, because the degrees of association between each of the historical orders and the target order may differ greatly, a weight value may make the prediction more accurate. For example, when it is determined that the Mahalanobis distance or the Euclidian distance between one feature of the target order and one feature of the historical order feature is smaller than the preset threshold, different weight values may be set to the order data when the Mahalanobis distance or the Euclidean distance is different. For example, when the starting location and the destination location of a historical order are the same as the starting location and the destination of the target order, respectively, the weight value is maximized. It may make the prediction more accurate when taking different weight values into consideration. Thus, in one embodiment, the value of the target order may be determined based on the weighted average value of the mileages of the historical orders and a weighted average value of the prices of the historical orders associated with the target order.

It should be noted that the above description of the method of determining the target order value is merely an example. For those skilled in the art, the method of determining the target order value may include a method of determining the historical order value, which has been described above with reference to FIG. 5A in detail, and will not be described again.

According to some embodiments of the present disclosure, as shown in FIG. 3, the system for predicting the order value may include a receiving module, an analyzing module, a processing module, and an output module in the server. FIG. 7B is a block diagram of a system for predicting the order value according to some embodiments of the present disclosure. To facilitate understanding of the present disclosure, the system will be described below with reference to the user maintenance system 101 shown in FIG. 3. The receiving module 301 in FIG. 3 may be the same as and/or similar to an obtaining module 721, the analyzing module 302 may be the same as and/or similar to a generating module 722, and the processing module may be a predicting module 723 and an updating module. The system for predicting the order value may include the obtaining module 721, the generating module 722, and the predicting module 723. The obtaining module 721 may obtain the features associated with the order value from the historical orders. The generating module 722 may generate a mapping model between the features and the order values. The predicting module 723 may predict the order value of the new order based on the mapping model and the data of the new order data. According to some embodiments of the present disclosure, the system may also include the updating module that may update the mapping model based on the data of the new order. Based on the data of the historical orders and the data of the new order, the system may predict the mileage and the price of the new order. The prediction may include, but is not limited to, obtaining the features associated with the order value from the historical orders, generating the mapping model between the features and the order values; and predicting the value of the new order based on the mapping model and the data of the new order. The predicted mileage and the predicted price of the new order may then be feedback to the user through the output module 304.

According to some embodiments of the present disclosure, the features associated with the order value may include the longitude of the starting location(s), the latitude of the starting location(s), the longitude of the destination location(s), the latitude of the destination location(s), the starting time of order(s), or the like, or any combination thereof. According to some embodiments of the present disclosure, the predicting module may include, but is not limited to, an extracting sub-module and a determining sub-module. The extracting sub-module may extract the features associated with the order value of the new order. The determining sub-module may determine the order value of the new order based on the mapping model and the data of the new order. For example, the predicting module may determine the order value of the new order as an average value of the values of the historical orders associated with the new order. As another embodiment, the predicting module may determine the order value of the new order as the weighted average value of the values of the historical orders associated with the new order. In some embodiments, the predicting module may further determine the association between one historical order and the new order based on whether the metric distance between the feature(s) of the new order and the feature of the historical order is less than the preset threshold. In some embodiments, the metric distance may include the Mahalanobis distance or the Euclidean distance. According to an embodiment of the present disclosure, the predicting module may set the threshold according to a Gaussian distribution.

It should be noted that the above description of the process of determining the user value (as shown in step 202) is merely an example, and not intended to be limiting the scope of the present disclosure. For those skilled in the art, after understanding the basic principles of the present disclosure, the form and details of the process of determining the user value may be modified or varied without departing from the principles. For example, the modules or steps described in the application may be implemented by certain general computing devices. In some embodiments, the modules may be in one general computing device. In some embodiments, the modules may be distributed in a network formed by a plurality a computing device. In some embodiments, steps may be implemented as computer-readable instructions. The instructions may be stored in a storage device to be performed. The instructions may also be integrated into integrated circuit modules, respectively. The applications are not limited to the combination of some certain hardware or software, which is merely an example, not intended to be limiting the scope of the present disclosure. For persons having ordinary skills in the art, multiple variations and modifications may be made under the teachings of the present disclosure. However, those variations and modifications do not depart from the scope of the present disclosure.

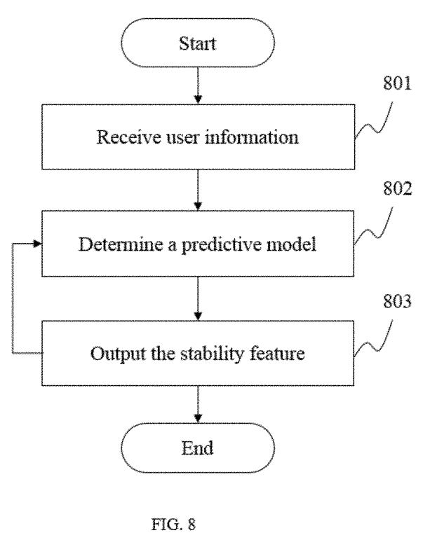

FIG. 8 is a flowchart of an exemplary process for determining the user stability according to some embodiments of the disclosure. As shown in FIG. 8, the user information may be received. The user may be a user of a product. In some embodiments, the product may be tangible or intangible. A tangible product may be in any size or shape. The tangible product may include food, medicine, commodity, chemical product, electrical appliance, clothing, car, housing, luxury, or the like, or any combination thereof. The intangible product may include a service product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a terminal, a program, a system, or the like, or any combination thereof. The terminal may include a tablet computer, a laptop computer, a mobile phone, a personal digital assistance (PDA), an electronic watch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application relating to transporting (also referred to herein as “transport software and/or application”) may include a traveling software and/or application, a vehicle reservation software and/or application, etc. In the vehicle reservation software and/or application, the vehicle may include a car (e.g., a taxi, a bus, etc.), a train, a subway, a vessel, an aircraft (e.g., an airplane, a helicopter, a rocket), a hot-air balloon, or the like, or any combination thereof.

For the software and/or application to transporting, the user may include a passenger, a driver, or any person. The user information may include information of user identity (also referred to herein as “user identity information”), order information, or any other information. The user identity information may include, but is not limited to, an account number, a password, an avatar, a gender, memo information, authentication information, or the like, or any combination thereof. The authentication information may include, but is not limited to, a user's nationality, an identity card, a driver license, a passport, a cell phone number, a mailbox, a user name (e.g., one or more user names in a social network), or the like, or any combination thereof. The order information may include, but is not limited to, a starting time, an arrival time, a starting location, a destination location, an order publishing time, a vehicle type, the number of passengers, a single or double way travel, the amount of payment (or collection), the amount of red packets, a tip amount, the state that whether the order is cancelled or not, a success rate, a score, a recommendation, or the like, or any combination thereof. Other information may be any other information associated with the user including, but not limited to, user software configuration information, a type of the mobile device, a friend recommendation record, or an updating record of the software version.

It should be noted that the description above of the user information is merely for the purpose of illustration, and is not intended to limit the scope of the present disclosure. It should be appreciated by one skilled in the art that alterations, improvements, and modification for the user information may occur without departing from this principle. For example, for the aircraft software in the transport software, the user information may be modified according to the aircraft usage scenario. For example, the user information for the aircraft software may include trip weather, the state that whether the aircraft may cross different countries, the state that whether the aircraft may delay, the state that whether there is a checked baggage, or the like, or any combination thereof. For other tangible products or intangible products, the user information may be modified according to the customary trading habits relating to the products. For example, for the tangible products, the user authentication information may further include the state that whether or not there is a contract or an agreement, and the order information may include the number of objects, the price of the objects, the time of ordering the objects, the place of ordering the objects, the time period of ordering the objects, the way of repayment (one-time repayment, installment), default treatment, compliance, buyer's or seller's credit, business conditions, or the like, or any combination thereof. These alterations, improvements, and modification are intended to be suggested by this disclosure and are within the spirit and scope of the exemplary embodiments of this disclosure.

In step 802, a model for predicting user stability may be determined based on to the user information. In some embodiments, the user stability may indicate a stability for a user to user one product. The predictive model of user stability may include a formula, a function, an algorithm, or a program that may use the unknown information to predict known information through building a model. In some embodiments, the predictive model(s) may be qualitative or quantitative. For a predicted quantitative model, it may be based on a temporal prediction method or a causal analysis method. The temporal prediction method may further include an average smoothing method, a trend extrapolation method, a seasonal variation prediction method, a Markov time series prediction method, or the like, or any combination thereof. The causal analysis method may further include a univariate regression method, a multiple regression method, and an input-output method. In some embodiments, the predictive model may include, but is not limited to, a weighted arithmetic average model, a trend average predictive model, an exponential smoothing model, an average development speed model, a one-dimensional linear regression model, a high and low point models, or the like, or any combination thereof. In some embodiments, these predicted model may have leaning capabilities, that is, feedback optimization algorithms based on the results, as described elsewhere in the disclosure.

In step 803, one or more user stability features may be obtained according to the predictive model above. The user stability feature(s) may be a parameter indicating a user grade, a loyalty degree, the state that whether a user will be lost from the online taxi-hailing platform, a user retention rate, a user satisfaction degree, etc. To facilitate understanding of the present disclosure, the user grade is described below. For example, according to the processing and analysis of the user information using the predictive model, the users may be rated according to the usage of products. In some embodiments, the users may include an important user, a main user, a general customer, a small customer, or any other grades. In other embodiments, the user may include a real user, a potential user, a target user, a loss user, or the like. The parameters indicating user stability may include one grade, probability, judgment, a piece of description, alarm, a maintenance plan, or the like, or any combination thereof, which may change depending on the specific usage scenario.

In some embodiments, after step 803, the predictive model may also be optimized continuously using machine learning techniques based on the predicted user stability features and the actual user stability features. The method of machine learning may include supervised learning, unsupervised learning, semi-supervised learning or intensive learning according to the different learning ways. The algorithm used in the machine learning may include a regression algorithm learning algorithm, an instance-based learning algorithm, a normalized learning algorithm, a decision tree learning algorithm, a Bayesian learning algorithm, a clustering algorithm learning algorithm, an association rule learning algorithm, a neural network learning algorithm, a deep learning algorithm, and a reduced dimension algorithm learning, etc.

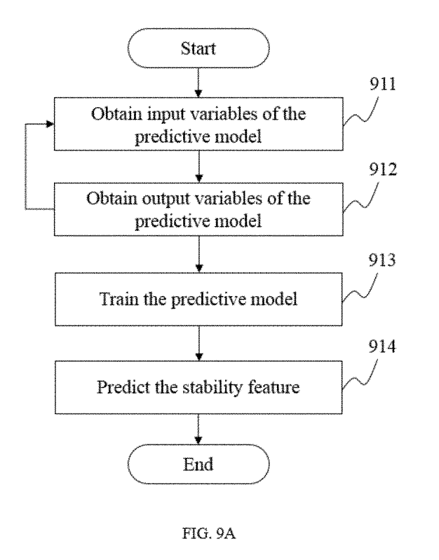

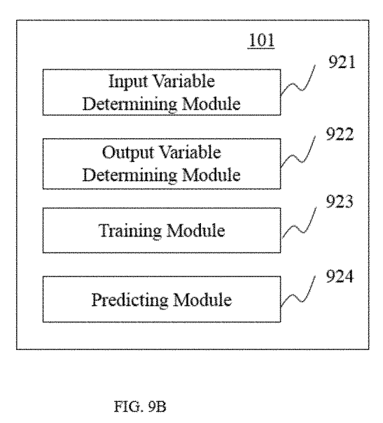

To facilitate understanding of the present disclosure, the flowchart of predicting the user stability of the vehicle reservation software is described below as an example, as shown in FIG. 9A. According to some embodiments of the present disclosure, the prediction problem to be solved in FIG. 9A is to predict whether a user will continue to use an online taxi-hailing platform in the future, based on the known usage data of the user on the online taxi-hailing platform.

In step 911, one or more input variables of a predetermined predictive model may be obtained based on the user information. The user information herein may be with reference to other related description of the present disclosure. For those skilled in the art, the prediction problem whether the user(s) of the online taxi-hailing platform will continue to use the online taxi-hailing platform may be a probabilistic problem or a binary classification problem. To facilitate understanding of the disclosure, the embodiments illustrated in FIG. 9A may be based on a binary classification problem, i.e., “loss” or “non-loss.” However, these examples are merely provided to facilitate understanding of the present disclosure and are not intended to limit the scope of the present disclosure. For such a binary prediction problem, a predictive model may be built based on a prediction algorithm. The prediction algorithm may include, but is not limited to, a regression algorithm, an instance-based algorithm, a normalized algorithm, a decision tree algorithm, a Bayesian algorithm, a clustering algorithm, an association rule algorithm, a neural network algorithm, a deep learning algorithm, and a reduced dimension algorithm, or the like, or any combination thereof. More particular, for example, the regression algorithm may include an Ordinary Least Square, a Logistic Regression, a Stepwise Regression, a Multivariate Adaptive Regression Spline, a Locally Estimated Scatterplot Smoothing, etc. The instance-based algorithm may include a k-Nearest Neighbor (KNN), a Learning Vector Quantization (LVQ), a Self-Organizing Map (SOM), etc. The normalized algorithm may include a RIDge Regression, a Least Absolute Shrinkage and Selection Operator (LASSO), or an Elastic Net. The decision tree algorithm may include a Classification And Regression Tree (CART), an ID3 (Iterative Dichotomiser 3), a C4.5, a Chi-squared Automatic Interaction Detection (CHAID), a Decision Stump, a Random Forest, a Multivariate Adaptive Regression Spline MARS), or a Gradient Boosting Machine (GBM), etc. The Bayesian algorithm may include a naive Bayesian algorithm, an Averaged One-Dependence Estimators (AODE) or a Bayesian Belief Network (BBN), etc. The kernel-based algorithm may include a Support Vector Machine (SVM), a Radial Basis Function (RBF), or a Linear Discriminate Analysis (LDA), etc. The clustering algorithm may include a k-Means algorithm or an Expectation Maximization (EM), etc. The association rule algorithm may include an Apriori algorithm or an Eclat algorithm, etc. The neural network may include a Perceptron Neural Network, a Back Propagation, a Hopfield Network, a Self-Organizing Map (SOM), a Learning Vector Quantization (LVQ), etc. The deep learning algorithm may include a Restricted Boltzmann Machine (RBN), a Deep Belief Networks (DBN), a Convolutional Network, a Stacked Autoencoders, etc. The reduced dimension algorithm may include a Principle Component Analysis (PCA), a Partial Least Square Regression (PLS), a Sammon mapping, a Multi-Dimensional Scaling (MDS), a (Projection Pursuit), etc. It should be noted that one skilled in the art may use other predictive models not described herein according to the particular application environment and other relevant contexts, the implementation of the present disclosure is not limited to a particular predictive model.

According to some embodiments of the present disclosure, in step 911, the input variables of the predetermined predictive model may be obtained based on the user behavior variables. The user behavior variables may be derived from the user information. The user identity information may include, but is not limited to, an account number, a password, an avatar, a gender, memo information, authentication information, or the like, or any combination thereof. The authentication information may include, but is not limited to, a user's nationality, an identity card, a driver license, a passport, a cell phone number, a mailbox, a user name (e.g., one or more user names in a social network), or the like, or any combination thereof. The order information may include, but is not limited to, the starting time of an order, an arrival time of the order, a starting location, a destination location, an order publishing time, a vehicle type, the number of passengers, a single or double way travel, the amount of payment (or collection), the amount of red packets, a tip amount, the state that whether the order is cancelled or not, a success rate, a score, a recommendation, or the like, or any combination thereof. Other information may be any other information associated with the user including, but not limited to, user software configuration information, a type of the mobile device, a friend recommendation record, or an updating record of the software version. Thus, the historical behavior features on the online taxi-hailing platform may be considered in the predetermined predictive model, thereby a prediction plan based on the historical usage behavior features to predict whether the user will be lost in the future may be realized.

To facilitate understanding of the present disclosure, an embodiment in which a plurality of input variables are obtained based on the values of each of a plurality of behavior variables in different time periods will be described. For example, if the predictive model includes N input variables, and there are two behavior variables taken into consideration, represented as-behavior variable A and -behavior variable B. The N input variables may be obtained based on value A1 of the behavior variable A in the early of the last month, value A2 of the behavior variable A in the middle of the last month, value A3 of the behavior variable A in the late of the last month, and value B1 of the behavior variable B in the early of the last month, value B2 of the behavior variable B in the middle of the last month, and/or value B3 of the behavior variable B in the late of the last month. A specific method may be a predetermined operation on the values of the behavior variables at different time periods, so that a plurality of input variables may be obtained.

According to some embodiments of the present disclosure, in step 911, a plurality of the input variables may be obtained by at least one of the values of the plurality of user behavior variables in different time periods, differences between the values, ratios between the values, average values of the values, and/or variance values of the values. For example, in the above-described example, in step 911, the N input variables may be formed using A1, A2, A3, B1, B2, B3, similar differences such as (A1−A2), (B1−B2), or (A1−B2), the ratios such as A1/A2, B1/B3, or A1/B1, the average values and variance values of the values A1 to A3 and B1 to B3. For those skilled in the art, other operations not described in the embodiments of the present disclosure may also be used to form a plurality of input variables from the values of each user behavior variable in different time periods. In some embodiments, there may also be a preprocessing process for behavior variables, for example, removing some distorted data. In some embodiments, the method to remove the distorted data may include, but is not limited to, a discriminant method, a culling method, an averaging method, a flattening method, a proportional method, a moving average method, an exponential smoothing method, a difference method, or the like, or any combination thereof.

It should be noted that the embodiments described above is merely provided for the purpose of illustration, and is not intended to limit the scope of the present disclosure. For one skilled in the art, those alterations, improvements, and modification for the way to determine the input variables may occur without departing from this principle. For example, the number of input variables, N, may be set adaptively according to the specific prediction requirement or the prediction structure. In addition, the number of user behavior variables is not limited to two, and the N input variables may be produced based on more or less number of behavior variables according to the actual application. The behavior variables may be treated indiscriminately, or also be given a specific weight. For example, the behavior variables employed in step 911 may also include the number of orders, the online duration, and the number of unused days. Step 911 may be performed by preferably selecting the behavior variables, such as the number of orders, the online duration, the number of unused days, etc., since the usage behaviors of the loss users before dropping will be decreased. That is, the values of the user behavior variables will generally decrease. In addition, the “last month,” “early,” “middle,” and “late” in the embodiments described above are also specific examples of “different time periods” in steps. And in practical applications, the persons skilled in the art can make other selections based on the actual situation, for example, “one day,” “one week,” “one month,” or a longer or shorter time range. These alterations, improvements, and modification are intended to be suggested by this disclosure and are within the spirit and scope of the exemplary embodiments of this disclosure.

In step 912, the variables that may determine whether the user will be lost may be determined as output variables of the predictive model. As described above embodiment, the prediction problem whether the user(s) of the online taxi-hailing platform will be lost may be a binary classification problem, including loss or non-loss. Thus, the output variables of the predictive model should be a variable with only two possible values, and the two possible values correspond to the user that will be or not be lost, respectively. For those skilled in the art, after understanding the basic principles of the present disclosure, the output variables may be deformed without departing from these principles. For example, the output variables may include a grade, probability, judgment, a piece of description, alarm, a maintenance plan, or the like, or any combination thereof, which may be changed depending on the specific usage scenario.

According to some embodiments of the present disclosure, step 912 may also include filtering the input variables of the predetermined predictive model by performing correlation analysis or data distribution analysis on the input and output variables. Step 912 may also include performing correlation analysis, data distribution analysis and other basic analysis on the input and output variables to eliminate the variables, including, e.g., the variables of which the input parameters may be with large correlation, the variables with small correlation between the input variable(s) and output variable(s), the variables of which the data distribution tends to be focused. Step 912 may also include removing irregular data.

In step 913, the input variables and output variables may be used as historical data to train the predictive model. To facilitate understanding of the present disclosure, some embodiments of a training method in the present disclosure are given below, but the present disclosure is not limited to these embodiments. For example, the training method may include steps: inputting the input variables to the predictive model; calculating the values of the output variables; comparing the calculated values of the output variables with the known values of the output variables to obtain an error; adjusting the predictive model according to the error; and iteratively performing step of calculating, comparing and adjusting until the error is zero or the number of iterations reaches a predetermined maximum number of times. For those skilled in the art, the maximum number of times may be set in accordance with the particular application environment.

According to some embodiments of the present disclosure, if the predictive model is a model based on the neural network algorithm (also referred to herein as a “neural network module”), the adjusting of the predictive model according to the error may include adjusting at least one of the number of the input variables of the neural network model, the number of hidden layers, the number of neurons in the hidden layers, the transfer function of the hidden layers, and the transfer function of the output layer. The adjusting of the transfer function of the hidden layers may further include adjusting the weight coefficients of the neurons.

In step 914, it may be predicted whether a user will be lost based on the trained predictive model. According to some embodiments of the present disclosure, the values of the N input variable may be obtained from the behavior variables generated by the user using the online taxi-hailing platform recently, and the values of the input variables may be input to the trained predictive model. Based on the trained predictive model, a prediction result whether the user will be lost may be obtained.

According to some embodiments of the present disclosure, the predictive model may be evaluated and optimized after obtaining the prediction result based on the trained predictive model. For example, at least one of the followings may be used as an evaluation index to evaluate the prediction result of the predictive model, e.g., an accuracy rate, a coverage rate, a ratio of the number of the samples judged as loss samples correctly to the number of the actual loss samples, or a ratio of the number of the samples judged incorrectly as loss samples to the number of the actual loss samples. Based on the evaluation index, the predictive model may be adjusted and optimized, and an optimal predictive model may be selected from the plurality of the trained predictive models.

It should be noted that the embodiments for determining the user stability described above is merely provided for the purpose of illustration, and is not intended to limit the scope of the present disclosure. For one skilled in the art, those alterations, improvements, and modification for the process of determining the user stability may occur without departing from this principle. For example, the user behavior variables may be preprocessed before obtaining the input variables of the predictive model. The mathematical method that can be used to preprocess may include, but is not limited to, a discriminant method, a culling method, an averaging method, a flattening method, a proportional method, a moving average method, an exponential smoothing method, a difference method, or the like, or any combination thereof. The irregular data may also be cleaned according to the feedback of the output variables in step 912. For example, after obtaining the prediction about the user stability, a maintenance plan may be developed for the corresponding user according to the prediction, such as sending reminders, coupons, vouchers, red packets, platform subsidies, pushing high-grade users, providing more additional services, etc. The maintenance plan may be used to recover the loss user(s). These alterations, improvements, and modification are intended to be suggested by this disclosure, and are within the spirit and scope of the exemplary embodiments of this disclosure.

According to some embodiments of the present disclosure, in order to implement the method of determining the user stability described in FIG. 9A, the present disclosure also provides an exemplary user maintenance system 101 for determining the user stability (also referred to herein as a “user stability determination system”). In some embodiments, the user stability determination system may include an input variable determining module 921, an output variable determining module 922, a training module 923, and a predicting module 924.

According to some embodiments of the present disclosure, the input variable determining module 921 may obtain the input variables of the predetermined predictive model based on the user behavior variables. The output variable determining module 922 may determine the variables that may be used to determine whether the user will be lost as the output variables of the predictive model. The training module 923 may train the predictive model with the input variables and the output variables that may be determined as historical data. The predicting module 924 may predict whether the user will be lost based on the trained predictive model.

According to some embodiments of the present disclosure, the predetermined predictive model may include, but is not limit to, a regression algorithm, an instance-based algorithm, a normalized learning algorithm, a decision tree algorithm, a Bayesian algorithm, a clustering algorithm, an association rule algorithm, a neural network algorithm, a deep learning algorithm, a reduced dimension algorithm, or the like, or any combination thereof.

In some embodiments, the input variable determining module 921 may further obtain a plurality of the input variables based on the values of each of the plurality of user behavior variables in different time periods. In some embodiments, the input variable determining module 921 may further obtain a plurality of the input variables by at least one of the values of the plurality of user behavior variables in different time periods, the differences between the values, the ratios between the values, the average values of the values, and/or the variance values of the values.

According to some embodiments of the present disclosure, the user behavior variables may include the number of times of receiving orders and the online duration. According to some embodiments of the present disclosure, the output variable determining module may determine a variable with only two possible values for the output variable, and the two possible values correspond to the case that the user will be or not be lost, respectively.

According to some embodiments of the present disclosure, the input variable determining module 921 may further filter the input variables of the predetermined predictive model based on the correlation analysis or data distribution analysis on the input and output variables.

According to some embodiments of the present disclosure, the training module 923 may further be configured to input the input variables to the predictive model; to calculate the values of the output variables; to compare the calculated values of the output variables with the known values of the output variables to obtain an error; to adjust the predictive model according to the error; to calculate, and to iteratively perform the operations of calculation, comparison and adjustment until the error is zero or the number of iterations reaches the predetermined maximum number of times.

According to some embodiments of the present disclosure, if the predicted model is a neural network model, the training module 923 may be configured to adjust, based on the error, at least one of the number of input variables of the model, the number of hidden layers, the number of neurons in the hidden layers, the transfer function(s) of the hidden layers, and the transfer function(s) of the output layer.

According to some embodiments of the present disclosure, the user stability determination system may further include an evaluating module that may be configured to evaluate the predictive model.

According to some embodiments of the present disclosure, at least one of the followings may be used as an evaluation index to evaluate the prediction results of the predictive model: an accuracy rate, a coverage rate, a ratio of the number of the samples judged as loss samples correctly to the number of the actual loss samples, or a ratio of the number of the samples judged incorrectly as loss samples to the number of the actual loss samples. Based on the evaluation index, the predictive model may be adjusted and optimized, and an optimal predictive model may be selected from the plurality of the trained predictive models. According to some embodiments, a method in a ROC space may be used to evaluate the prediction results of the predictive model.

It should be noted that the description of the user stability determination system is merely provided for the purpose of illustration, and is not intended to limit the scope of the present disclosure. For one skilled in the art, those alterations, improvements, and modification for the user stability determination system may occur without departing from this principle. For example, the user stability determination system may belong to or be independent of the user maintenance system shown in FIG. 3. The input variables determining module, the output variables determining module, the training module and/or the predicting module described above may be separate, paired, or in groups integrated into the user maintenance system when the user stability determination system belongs to the user maintenance system. These alterations, improvements, and modification are intended to be suggested by this disclosure and are within the spirit and scope of the exemplary embodiments of this disclosure.

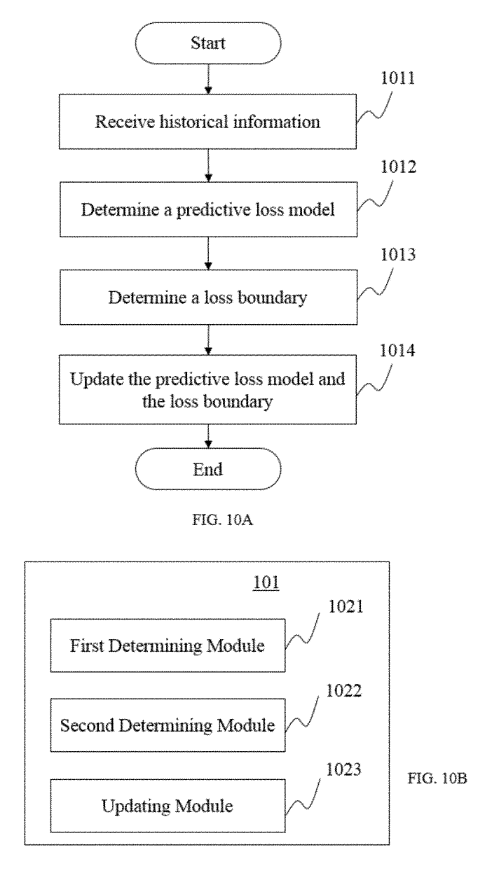

FIG. 10A is a flowchart of another exemplary process for determining the user stability according to some embodiments of the disclosure. To facilitate understanding of the present disclosure, this disclosure takes the loss prediction as an example of the stability prediction, but the present disclosure is not limited to these embodiments. In step 1011, historical information may be received as shown in FIG. 10A. The historical information may be user information described elsewhere in the present disclosure including, but not limited to, user identity information, order information, or other information. The user identity information may include, but is not limited to, an account number, a password, an avatar, a gender, memo information, authentication information, or the like, or any combination thereof. The authentication information may include, but is not limited to, a user's nationality, an identity card, a driver license, a passport, a cell phone number, a mailbox, a user name (e.g., one or more user names in a social network), or the like, or any combination thereof. The order information may include, but is not limited to, a starting time of an order, an end time of the order, a starting location, a destination location, an order publishing time, a vehicle type, the number of passengers, a single or double way travel, the amount of payment (or collection), the amount of red packets, a tip amount, the state that whether the order is cancelled or not, a success rate, a score, a recommendation, or the like, or any combination thereof. Other information may be any other information associated with the user including, but not limited to, user software configuration information, a type of the mobile device, a friend recommendation record, or an updating record of the software version.

In step 1012, a predictive loss model may be determined for each user based on the historical information. In some embodiments, the predictive loss model may include, but is not limited to, a weighted arithmetic average model, a trend average predictive model, an exponential smoothing model, an average development speed model, a one-dimensional linear regression model, a high and low point model, or the like, or any combination thereof. In some embodiments, the predictive loss model may also be capable of learning. For example, the predictive model may be optimized based on results. The models capable of learning may include, but is not limited to a regression algorithm model, an instance-based model, a normalized learning model, a decision tree model, a Bayesian model, a clustering algorithm model, an association rule model, a neural network model, a deep learning model, a reduced dimension algorithm model, or the like, or any combination thereof.

In step 1013, a loss boundary of each user may be determined based on the predictive loss model.

In step 1014, the corresponding loss predicted model and the corresponding loss boundary may be updated based on one or more time intervals at which the user initiates new orders. In some embodiments, a user may be determined as a loss user when the time interval exceeds the corresponding loss boundary.

In some applications, in steps 1012 and 1013, the determining of the corresponding loss predictive model for each user based the historical data and the determining of the corresponding loss boundary of each user based on the corresponding predictive loss model may be performed on-line or off-line.

In step 1014, an on-line system may be used to load the predictive loss model determined in step 1012, and to update the corresponding predictive loss model and the corresponding loss boundary based on the one or more time intervals at which the user initiates the new orders.

In some embodiments, the loss boundary may be indicated by a usage interval value of the user. The usage interval value may be a smoothing value or an average value of the historical usage time intervals.

In the embodiment that the usage interval is an indicator indicative of whether a user will be lost, the corresponding predictive loss model may be determined for each user based on the historical data. The process may include determining the time intervals at which the user initiates orders; determining one or more time-fluctuation value of the time intervals at which the user initiates orders; and determining the corresponding predictive loss model for the user based on the time intervals and the time-fluctuation values of the time intervals.

In some embodiments, the time intervals at which the user initiates an order may be expressed as Equation 19:

SUSE_{L}=α×SUSE_{L}+(1−α)×USEₛₐₘₚₗₑ, (Equation 19)

wherein “SUSE_{L}” may represent the predicting usage interval for the user; “USEₛₐₘₚₗₑ” may represent the time interval at which the user initiates an order; and “α” is a fixed constant. In various embodiments, “α” may be different. For example, in some embodiments, “α” is 7/8, then Equation 19 may be expressed as SUSE_{L}=7/8×SUSE_{L}+1/8×USEₛₐₘₚₗₑ.

The time interval in the predictive loss model may be determined based on the time interval at which the user initiates a new order and the time interval from the previous prediction. The initial value of the time interval of the iterative algorithm represented by Equation 19 may be selected as a fixed value according to the practical application, for example, the initial value may be 0 or 1.

In some embodiments, a time-fluctuation value model for the time interval at which the user initiates an order is expressed as follows:

SDELTA_{L}=β×SDELTA_{L}+(1−β)×|USEₛₐₘₚₗₑ−SUSE_{L}|, (Equation 20)

wherein “SDELTA_{L}” may represent a predicted time-fluctuation value of the time intervals at which the user initiates orders; and “β” is a fixed constant. In various embodiments, “β” may be different. For example, in some embodiments, “β” is 3/4, then equation 20 may be expressed as SDELTA_{L}=3/4×SDELTA_{L}+1/4×|USEₛₐₘₚₗₑ−SUSE_{L}|.

The time-fluctuation value of the time intervals in the predictive loss model may be determined based on the time interval(s) at which the user initiates new orders, the time intervals in the predictive loss model, and the time-fluctuation value of the time intervals from the previous prediction. The initial value of the time-fluctuation value of the iterative algorithm represented by Equation 20 may be selected as a fixed value according to the practical applications, for example, the initial value may be 0 or 1.

It should be noted that the description of equation 19 and equation 20 is merely provided for the purpose of illustration, and is not intended to limit the scope of the present disclosure. For one skilled in the art, alterations, improvements, and modification of the predictive model may occur without departing from this principle. It will be apparent to those skilled in the art that the principles of the present disclosure may be followed to alter, adjust or modify the predictive model without departing from this principle. As one example, with respect to equation 19 and equation 20, the forms may be changed, for example, by adding some items or reducing some items, adding some parameters or reducing some parameters. Further, the predictive model is not limited to the forms of Equation 19 or Equation 20. One skilled in the art may select other functions, formulas, or algorithms according to the requirements of the specific stability characteristics. These alterations, improvements, and modification are intended to be suggested by this disclosure and are within the spirit and scope of the exemplary embodiments of this disclosure.

As shown above, the corresponding predictive loss model may be determined for each user, and the predictive model may be iterated based on the historical data according to equation 19 and equation 20. Based on the learning of the historical data, the predicted usage interval for the user (SUSE_{L}) and the predicted time-fluctuation value of the time interval(s) at which the user initiates orders (SDELTA_{L}) may be updated continuously.

In some embodiments, the loss boundary of each user may be determined using the time interval(s) at which each user initiates the orders and the corresponding time-fluctuation value of the time interval(s). For example, in some embodiments, the loss boundary may be defined as SUSE_{L}+4×SDELTA_{L}. If the usage interval value is greater than SUSE_{L}+4×SDELTA_{L}, it may be determined that the user has been lost. In various embodiments, the definition of the loss boundary may vary according to the particular application.

It should be noted that the above description of the process of predicting user loss boundary is merely provided for the purpose of illustration, and is not intended to limit the scope of the present disclosure. For one skilled in the art, alterations, improvements, and modification for the process of predicting user loss boundary may occur without departing from this principle. For example, the process is not limited to predict user loss boundary, and may also be used to predict other features of user stability, for example, a degree of loyalty, a loss probability, a retention rate, etc. As another example, in step 1014, the training model or machine learning model described elsewhere in the present disclosure may also be applied to update the predictive model and the loss boundary. As another example, after obtaining the loss boundary, if the user has not used the taxi software again after being close to the loss boundary, a maintenance plan for the corresponding user may be developed, such as sending reminders, coupons, vouchers, red packets, platform subsidies, pushing high-grade users, providing more additional services, etc. The maintenance plan may be used to recover the user that will be lost. These alterations, improvements, and modification are intended to be suggested by this disclosure and are within the spirit and scope of the exemplary embodiments of this disclosure.

In accordance with some embodiments of the present disclosure, in order to implement the method of determining the user loss boundary described in FIG. 10A, the present disclosure also provides an embodiment in which the user maintenance system 101 may implement the method. In some embodiments, the system for determining the user loss boundary may include a first determining module 1021, a second determining module 1022, and an updating module 1023. The first determining module 1021 may be configured to determine the corresponding predictive loss model for each user based on the historical data. The second determining module 1022 may be configured to determine the user loss boundary based on the predictive loss model. The updating module 1023 may be configured to update the corresponding predictive loss model and the corresponding loss boundary based on the time interval(s) at which the user initiates the new orders. In some embodiments, the first determining module 1021, the second determining module 1022, and/or the updating module 1023 may be standalone devices in the user maintenance system 101 or may be separate, paired, in groups integrated into the analyzing module 302 and/or the processing module 303.

In some embodiments, the user maintenance system 101 may further include a third determining module that may be configured to determine a user as the loss user when the time interval at which the user initiates an order exceeds the corresponding loss boundary.

In some embodiments, the first determining module 1021 may further include a first determining sub-module configured to determine the time interval at which the user initiates an order; a second determining sub-module configured to determine the time-fluctuation value of the time interval(s) at which the user initiates orders; and a third determining sub-module configured to determine the predictive loss model based on the time interval(s) and the time-fluctuation value of the time interval(s).

In some embodiments, the first determining sub-module may be configured to determine the time interval in the predictive loss model based on the time interval(s) at which the user initiates the new order(s) and the time interval from the previous prediction. In some embodiments, the second determining sub-module may be configured to determine the time-fluctuation value for the time interval(s) in the predictive loss model based on the time interval at which the user initiates a new order, the time interval in the predictive loss model, and time-fluctuation value of the time interval from the previous prediction.

In some embodiments, the second determining module 1022 may further be configured to determine the loss boundary of each user using the time interval(s) at which each user initiates the order(s) and the corresponding time-fluctuation value of the time interval(s).

It should be noted that the above description of the system for determining the user loss boundary is merely provided for the purpose of illustration, and is not intended to limit the scope of the present disclosure. For one skilled in the art, alterations, improvements, and modification for the system of determining the user loss boundary may occur without departing from this principle. For example, the system for determining the user loss boundary may belong to or be independent of the user maintenance system shown in the FIG. 3. The first determining module 1021, the second determining module 1022, and/or the updating module 1023 described above may be separate, paired, or in groups integrated into the module of a user maintenance system, in the case of belonging to the user maintenance system. These alterations, improvements, and modification are intended to be suggested by this disclosure and are within the spirit and scope of the exemplary embodiments of this disclosure.

The user maintenance method described in the present disclosure may also include a user friendship classification method. And then in the embodiment of the disclosure will be clearly and completely described below with reference to the drawings in the embodiments of the present disclosure. The described embodiments are only a part of the embodiments of the present disclosure, but not all embodiments. All other embodiments obtained by those ordinary skilled in the art based on the embodiments of the present disclosure without creative effort are without departing from the spirit and scope of the present disclosure.

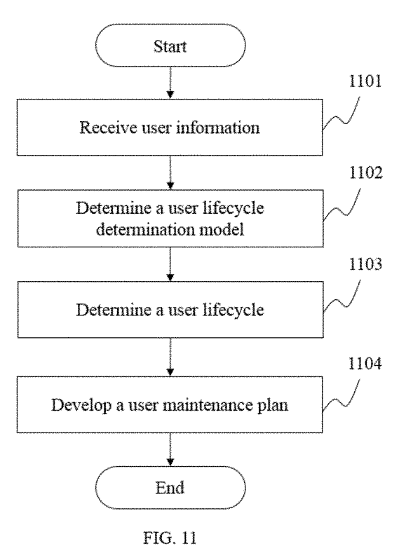

FIG. 11 is a flowchart of an exemplary process for user lifecycle determination and maintenance according to some embodiments of the present disclosure. As shown in FIG. 11, in step 1101, user information may be received. In the embodiment of the vehicle reservation platform, the user may be a driver or a passenger. The user information may include, but is not limited to, user identity information, order information, or other information. The user identity information may include, but is not limited to, an account number, a password, an avatar, a gender, memo information, authentication information, or the like, or any combination thereof. The authentication information may include, but is not limited to, a user's nationality, an identity card, a driver license, a passport, a cell phone number, a mailbox, a user name (e.g., one or more user names in a social network), or the like, or any combination thereof. The order information may include, but is not limited to, a starting time, an arrival time, a starting location, an destination location, an order publishing time, a vehicle type, the number of passengers, a single or double way travel, the amount of payment (or collection), the amount of red packets, a tip amount, the state that whether the order is cancelled or not, the number of orders strived, the number of orders received, a success rate, a score, a recommendation, or the like, or any combination thereof. The other information may include any other information associated with the user including, but not limited to, user software configuration information, a type of the mobile device, a friend recommendation record, or an updating record of the software version.

In step 1102, a model for determining the user lifecycle (also referred to herein as a “user lifecycle determination model”) may be determined based on the user information. In some embodiments, all of the user information may be input parameters of the user lifecycle determination model, and may be selected in accordance with actual needs. For ease of understanding, an embodiment of a driver's lifecycle may be illustrated in the following description. In such an embodiment, the input parameters of the lifecycle determination model may primarily refer to the number of orders received and the number of orders strived by the driver. In some embodiments, the two parameters may be used independently, or they may be given different weights to compute a composite indicator which may indicate a degree of driver's participation. For example, the degree of driver's participation in a unit of time may be calculated according to Equation 21, which may be expressed as:

θ=α*accept+strive, (Equation 21)

wherein “θ” may represent the degree of driver's participation in a unit of time; “accept” may represent the accepted order quantity of the driver in a unit of time; “strive” may represent the number of orders strived by the driver in a unit of time; and “a” may be a ratio of the average number of orders accepted to the average of the number of orders strived by all drivers in a unit of time. The unit of time may be selected in accordance with actual needs. For example, the unit of time may include one hour, one day, one week, one month, one year, etc.

In some embodiments, the degree of participation θ of the driver in the unit of time may be used as separate data. The degree of participation θ of the driver may also be used in conjunction with the driver's participation degree at other time units to form a set of feature data, for example, in the form of a feature vector. The dimension of the feature vector may be determined in accordance with actual needs. For example, in some embodiments, if the degrees of participation in N consecutive time units are to be taken into account, the dimension of the feature vector is N. For example, a 4-dimensional feature vector is illustrated. In this embodiment, the unit of time is one week. The degree of participation θ may indicate statistical data within one week. Taking consecutive four weeks as a unit of lifecycle, the feature data fₓⁱ of the driver at the present time instant “i” may be represented by a 4-dimensional feature vector, which may be expressed as Equation 22:

fₓⁱ=(θ₀,θ₁,θ₂,θ₃), (Equation 22)

In some embodiments, the feature data fₓⁱ may also be normalized.

According to some embodiments of the present application, user lifecycle determination model may also include some patterns in different stages of the lifecycle. These patterns may be derived from the historical data, expert experience, common sense judgment, model calculations, or learning of a system. As one example, a lifecycle including fives patterns will be described as follows. For example, these five patterns may include: a newborn period, a growth period, a stable period, a decay period, and a loss period. The newborn period may refer to a period in which for the data of consecutive four weeks, the participation degree is 0 in the first two weeks. From the third week, some participation data may be obtained. The growth period may refer to a period in which the participation degree may include an increasing trend in the consecutive four weeks. The stable period may refer to a period in which the participation degree may fluctuate smoothly in the four consecutive weeks. The decay period may refer to a period in which the participation degree may include a downward trend in the four consecutive weeks. The loss period may refer to a period in which there is no participation data within the four consecutive weeks. It should be noted that the above embodiments are described merely for the purpose of understanding the present disclosure. In a practical application, for persons having ordinary skills in the art, multiple variations, improvements, and modifications may be made to the number, contents or features of a lifecycle model. Those variations, improvements, and modifications do not depart from the scope of the present disclosure.

In some embodiments, the rules to determine different periods may be different from each other. For example, the rule for the determination of the newborn period and the rule for the determination of the loss period may be fixed. The definition of the loss period may be a period in which there is no participation data within the four consecutive weeks. The definition of the newborn period may be a period in which the participation degree is 0 for the first two weeks or three weeks, and the participation data begins to appear from the third week.

For the growth period, the decay period, and the stable period, some representative pattern vectors “pᵢ” may be defined. These vectors may be used to determine the driver's lifecycle periods by calculating the correlation between the feature vector and the pattern vector. These representative pattern vectors may be obtained by mapping the different patterns to three typical lifecycle pattern vectors, respectively.

$${p}_{j} = arg { max}_{0 \leq i \leq 2} sim ( {p}_{j} - {p}_{i} ) , \qquad ( Equation 23 )$$

wherein “i” may represent the three typical pattern vectors for any of the growth period, the stable period or the decay period; and “pⱼ” may represent the pattern vector to be defined. The above-obtained pattern mapping relationship may be manually verified for a more reliable pattern classification of a driver lifecycle.

It should be noted that the above description takes a driver as an example. It will be apparent to those skilled in the art that the present invention may be applied to the lifecycle determination of a passenger based on the above description. For example, for the lifecycle determination model of the passenger, the input parameters may include the number of orders, the number of destructions, the times of clicking the taxi software, the updating times of the taxi software, scores to drivers, or the like, or any combination thereof. In addition, equations of the feature vector and the pattern vector to be defined described above are merely used for examples. The above equations may be varied or replaced by other equations on the premise that the same or similar function are achieved. These variations, improvements, and modifications do not depart from the scope of the present disclosure.

According to the user lifecycle predictive model, in step 1103, the lifecycle of the user is determined. According to the above definition, the feature vector of the user in the current time is represented as “fᵢ” and the pattern vector in different periods is represented as “pᵢ”, the feature vector may be expressed as Equation 24 and Equation 25.

fᵢ=(θ₀,θ₁,θ₂,θ₃), (Equation 24)

The determination method of the user lifecycle is:

for the newborn period: θ₀=θ₁=0; θ₂!=0
for the loss period: θ₀=θ₁=θ₂=θ₃=0
for other periods:

$${f}_{j} = arg { max}_{0 \leq i \leq 2} sim ( {p}_{j} - {p}_{i} ) \{ \begin{matrix}{p}_{i} ∈ the growth period \\ {p}_{i} ∈ the stable period \\ {p}_{i} ∈ the decay period\end{matrix} . \qquad ( Equation 25 )$$

According to the records of the user participation in the platform, a new user lifecycle description may be generated every day. Over time, the lifecycles of some users may include the whole process from the newborn period to the growing period, to the stable period, then to the decay period, and finally to the loss period. The lifecycles of some users may include the process from the newborn period, directly to the decaying period, and finally to the loss period. Some users will return to the platform after a long loss period, and become active users.

For the convenience of understanding and better support for the business, a more detailed division of the different periods may be made. TABLE 2 depicts an example of the user lifecycle patterns.

TABLE 2

| lifecycle pattern | The lifecycle type | Description |
|---|---|---|
| Newborn period | Newborn user | A newborn period during which there is no user |
| | | record in history |
| | Activated user | A newborn period during which there are user |
| | | records in history |
| Growth period | Visible growth | A growth period, three consecutive days after |
| | | which the user enters the stable period |
| | Invisible growth | A growth period, three consecutive days after |
| | | which that the user enters the loss period |
| Stable period | Low stable period | A stable period during which the degree of |
| | | participation is less than 1/3 |
| | Medium stable period | A stable period during which the degree of |
| | | participation is between 1/3 and 2/3 |
| | High stable period | A table period during which the degree of |
| | | participation is high than 2/3 |
| Decay period | Mild decay period | A decay period, three consecutive days before |
| | | which that the user is in the growth period or the |
| | | stable period |
| | Severe decay period | A decay period, three consecutive days before |
| | | which the user is still in the decay period |
| Loss period | New loss period | The user just enters the loss period |
| | Long loss | The user may be long-term in the loss period |

After determining the user lifecycle, a user maintenance plan may be developed in step 1104. In different lifecycle types, the following operation strategies may be adopted: first, pushing some information about some functions and delivering small amount of red packets for users in the newborn period; second, delivering red packets and carrying out offline activities for users in the low stable period; third, warning early through the platform and delivering the red packets for users in the mild decay period; forth, by delivering small amount of red packets and interviewing through a telephone randomly for the user in the severe decay period; and fifth, interviewing through a telephone randomly for users in the new loss period. The red packets may include, but are not limited to, tips, cash coupons, vouchers, discount coupons, platform subsidies, or the like, or any combination thereof. In order to achieve a better user maintenance, the above-described operation strategies may be modified in various details and combined corresponding. Those modifications and combinations do not depart from the scope of the present disclosure.

It may be rather apparent to those skilled in the art after understanding the content and principles of the present disclosure, the form and details (e.g., the order of some steps) may be modified or varied without departing from the principle. Those modifications and variations are still within the spirit and scope of the exemplary embodiments of this disclosure.

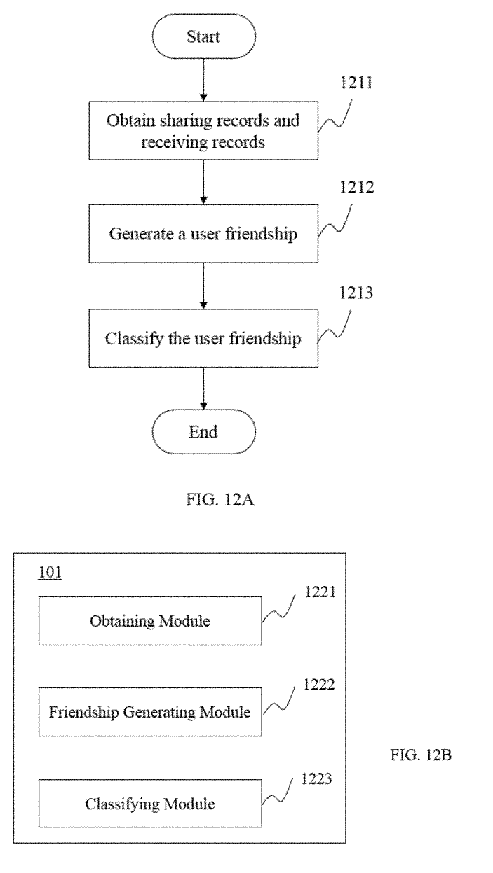

FIG. 12A is a flowchart of a method for classifying user friendships according to some embodiments of the present disclosure. As shown in FIG. 12, in step 1211, records of sharing (also referred to herein as “sharing records”) and records of receiving (also referred to herein as “receiving records”) may be obtained. In some embodiments, the sharing records and receiving records may be within a first predetermined time period. The sharing records may include records of the shareable information shared by at least one terminal. The receiving records may include records of the shareable information received by at least one terminal. The terminal may refer to a device on which social applications are installed, including but not limited to mobile phones, laptops, tablets, POS machines, or any other devices. The shareable information may include but is not limited to, text, numbers, pictures, videos, equipment, pets, virtual currency in online games, or the like, or any combination thereof. In some embodiments, the shareable information may include information in red packets. The information in red packets may include a coupon, a voucher, a greeting card, a gift, a point, a prize, or the like, or any combination thereof. Users may send and share the red packets with friends. For example, many users may use the red packets to get a discount in the existing taxi system. With more and more users, the taxi system may accumulate a large amount of data of sharing or receiving red packets.

In step 1212, a user friendship may be generated. In some embodiments, the user friendship may be generated based on the sharing records and the receiving records of shareable information. More particularly, for example, for each shareable information, the terminal sharing the shareable information may be associated with the terminal receiving the shareable information. An association record may represent a friend relationship. The list of friends of each terminal may be obtained based on multiple association records. In some embodiments, the shareable information may include data of red packets. The data of red packets may include sharing records and receiving records about red packets. The sharing records and the receiving records of the red packets may include IDs of the red packets. Based on the association between the sharing records and the receiving records relating to each ID, the association records between the sharers of red packets and the receivers of red packets may be obtained. After obtaining a number of association records, the list of friends of each terminal may be determined. It should be noted that the description of the process of determining the list of friends based on the red packets is provided merely for understanding and is not intended to be limiting the scope of the present disclosure. Those skilled in the art may apply it to other implementation scenarios of sharing information.

In some embodiments, the sharing records may include, but are not limited to, an identifier of the shareable information or an identifier of a first terminal sharing the shareable information. The receiving records may include, but are not limited to, an identifier of the shareable information and an identifier of a second terminal sharing the shareable information. In some embodiments, step 1212 may include the following operations: obtaining the sharing records and the receiving records with the same identifier of the shareable information, wherein the identifier of the shareable information may include an ID and the identifiers of the first terminal and the second terminal may include, but are not limited to, a mobile phone number, an IP address, a MAC address and so on; associating the first terminal relating to the sharing records with the second terminal relating to the receiving records; and generating the list of friends corresponding to each terminal based on the multiple association records. In step 1213, the user friendships may be classified. In some embodiments, the user friendships may be classified based on the user friendships and the common location data of each terminal in the user friendships. The common location data of each terminal in the user friendships may be the location data when the usage frequency obtained in advance in a second predetermined period is greater than a first predetermined threshold value. Specifically, the friendships may be classified into different types based on the comparison of the common locations of the two terminals in which the friendships exist. The types of the friendships may include, but are not limited to, neighbors, colleagues, family, friends, lovers, customers, leader-member relations and so on.

In some embodiments, step 1213 may include obtaining the common location data of each terminal in user friendships based on the user friendships. The common location data may include, but is not limited to, the preset coordinate information of the home, the coordinate information of the company, or the coordinate of other locations accessed frequently. In some embodiments, the location information of each terminal may be analyzed based on the historical order records for each terminal. The location information may include, but is not limited to, the coordinate information of the home, the coordinate information of the company and the coordinate information of other frequently accessed locations. Step 1213 may also include determining a distance between two homes, a distance between two companies, or a distance between other locations frequently accessed of the two terminals based on the common location data. If the distance between the two terminals is less than a first predetermined distance, the users corresponding to the two terminals may be determined as neighbors. If the distance between two terminals is less than a third predetermined distance, the users corresponding to the two terminals may be determined as families. The third predetermined distance is less than the first predetermined distance. If the distance between the two terminals is less than a second predetermined distance, the users corresponding to the two terminals may be determined as friends.

In some embodiments, step 1213 may also include the following operations: firstly, obtaining interaction data and a coverage rate of common friends for any two terminals in a friendship based on the user friendships. In some embodiments, the interaction data between terminal A and terminal B which may be in a friendship may include the number of pieces of shareable information shared by terminal A/B, the number of pieces of shareable information received by terminal A/B, the number of pieces of shareable information shared by terminal B and received by terminal A, and the number of pieces of shareable information shared by terminal A and received by terminal B. In some embodiments, the coverage rate of common friends may include a ratio of the number of common friends of terminal A and terminal B to the number of friends of terminal A or terminal B. In some embodiments, when the shareable information is the data of red packets, the interaction data obtained in this step may include, but is not limited to, the number of the red packets sent by a terminal, the number of red packets strived by the terminal, the number of red packets strived from one or more friends by the terminal, or the number of red packets strived from the terminal by one or more friends. Secondly, determining a friend-intimacy degree of two terminals based on the interaction data and the coverage rate of common friends. Thirdly, based on the friend-intimacy degree of two terminals and the common location data of either terminal in user friendships, classifying the user friendships.

In some embodiments, the process of calculating the friend-intimacy degree may include, based on the interaction data and the coverage rate of common friends, calculating the friend-intimacy degree f(ab) of terminal A for terminal B by Equation 26, which may be expressed as:

$$f ( ab ) = a * ( a 1 * \frac{{Q}_{ab} * {Q}_{ab}}{{F}_{b} * {T}_{a}} + a 2 * \frac{{Q}_{ba} * {Q}_{ba}}{{F}_{a} * {T}_{b}} ) + b * ( a 1 * \frac{{Com}_{ab} + 1}{{Fri}_{a}} + a 2 * \frac{{Com}_{ab} + 1}{{Fri}_{b}} ) , \qquad ( Equation 26 )$$

wherein “a,” “a1,” and “a2” may represent weights of the interaction data; “b” may represent a weight of the coverage rate of common friends; “Fₐ” may represent the number of pieces of shareable information shared by terminal A; “Tₐ” may represent the number of pieces of shareable information received by terminal A; “F_{b}” may represent the number of pieces of shareable information shared by terminal B; “T_{b}” may represent the number of pieces of shareable information received by terminal B; “Q_{ab}” may represent the number of pieces of shareable information shared by terminal B and received by terminal A; “Q_{ba}” may represent the number of pieces of shareable information shared by terminal A and received by terminal B; “Com_{ab}” may represent the number of common friends of terminal A and terminal B; “Friₐ” may represent the number of friends of terminal A; and “Fri_{b}” may represent the number of friends of terminal B.

In Equation 26,

$$\frac{{Q}_{ab}}{{F}_{b}}$$

may represent a degree of attention of terminal A to terminal B;

$$\frac{{Q}_{ab}}{{T}_{a}}$$

may represent a degree of contribution of terminal A to terminal B;

$$\frac{{Q}_{ba}}{{F}_{a}}$$

may represent a degree of attention of terminal B to terminal A;

$$\frac{{Q}_{ba}}{{T}_{b}}$$

may represent a degree of contribution of terminal B to terminal A;

$$\frac{{Com}_{ab} + 1}{{Fri}_{a}}$$

may represent ratio of the number of common friends of terminal A and terminal B to the number of friends of terminal A; and

$$\frac{{Com}_{ab} + 1}{{Fri}_{b}}$$

may represent a ratio of the number of common friends of terminal A and terminal B to the number of friends of terminal B.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of the present disclosure.

FIG. 12B is a block diagram of the user maintenance system for classifying user friendships according to some embodiments of the present disclosure. As shown in FIG. 12B, the system may include an obtaining module 1221, a friendship generating module 1222, and a classifying module 1223. It should be noted that the system described in this embodiments is based on the user maintenance system of the present disclosure. The obtaining module 1221 may be configured to obtain the sharing records and receiving records of each shareable information in the first predetermined time period, wherein the sharing records may include the shareable information records shared by at least one terminal, and the receiving records may include the shareable information records shared by at least one terminal. The friendship generating module 1222 may be configured to generate a user friendship corresponding to the shareable information based on the sharing records and receiving records of each shareable information. The classifying module 1223 may be configured to classify the user friendships according to the user friendships and the common location data of each terminal in the user friendships, wherein the common location data of each terminal may be location data with the usage frequency greater than the first predetermined threshold value in the second predetermined time period.

In some embodiments, the system for classifying user friendships may also include a friend-intimacy degree calculating module. The friend-intimacy degree calculating module may be configured to obtain the interaction data and the coverage rate of common friends between any two terminals in a friendship based on the user friendships. Based on the interaction data and the coverage rate of common friends, the friend-intimacy degree of two terminals may be determined. Based on the friend-intimacy degree of two terminals and the common location data of either terminal in the user friendships, the user friendships may be classified. In some embodiments, the sharing records include, but is not limited to, the identifier of the shareable information and the identifier of the first terminal sharing the shareable information. The receiving records may include, but is not limited to, the identifier of the shareable information and the identifier of the second terminal sharing the shareable information. In some embodiments, the system for classifying user friendships may further include the friendship generating module 1222. The friendship generating module 1222 may be configured to obtain the sharing records and the receiving records with the same identifier of the shareable information, to associate the first terminal in the sharing records with the second terminal in the receiving records. The friendship generating module 1222 may also be directed to generate the list of friends corresponding to each terminal based on multiple association records. The classifying module 1223 may be configured to obtain the common location data for each terminal in the user friendships, wherein the common location data may include, but is not limited to, the coordinate information of the home, the coordinate information of the company, and the coordinate information of other locations accessed frequently. Based on the common location data, the distance between two homes, the distance between two companies, and the distance between the other locations, frequently accessed of the two terminals may be obtained. If the home distance between the two terminals is less than the first predetermined distance, the users corresponding to the two terminals may be determined as neighbors. If the home distance between two terminals is less than the third predetermined distance, the users corresponding to the two terminals may be determined as families. If the company distance between the two terminals is less than a second predetermined distance, the users corresponding to the two terminals may be determined as friends.

For the embodiments of the system, since it is substantially similar to the method embodiments, the description is relatively simple, and the relevant aspects are described in the method embodiments. It should be noted that in the various parts of the system of the present application, the components therein are logically divided according to the functions to be implemented, but the present invention is not limited thereto. And the respective components can be re-divided or combined. For example, some components may be combined into a single component. Some components may be further broken down into more sub-components. In addition, it is also possible to add or subtract some modules when the same effect is achieved. For example, in order to store information that users share, the system may further include an identification module, an associating module, a storage module, or the like, all within the scope of the present application.

According to the user maintenance method described in the present disclosure may also include a user identification method. And the technical scheme in the embodiment of the present disclosure will be clearly and completely described below with reference to the drawings in the embodiments of the present disclosure. The described embodiments are only a part of the embodiments of the present disclosure, but not all embodiments. All other embodiments obtained by those ordinary skilled in the art based on the embodiments of the present application without creative effort are without departing from the spirit and scope of the present disclosure.

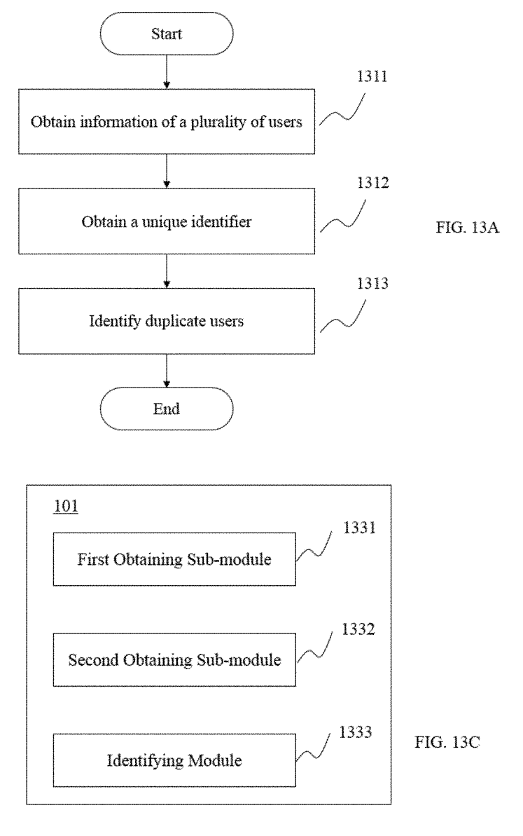

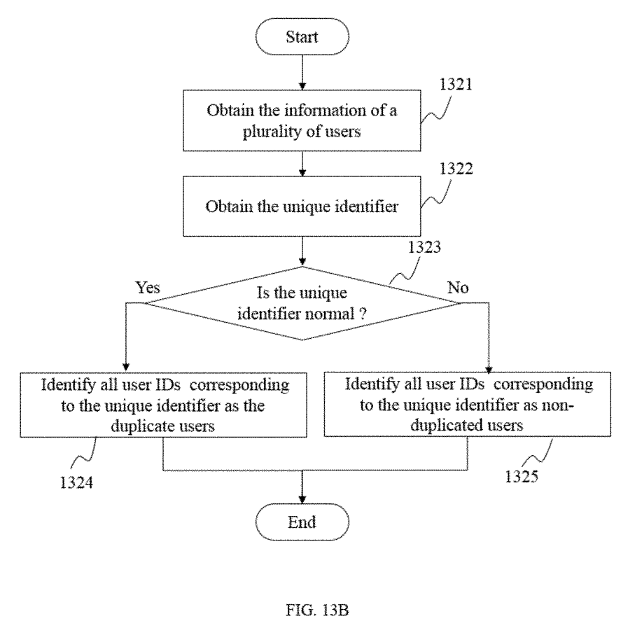

FIG. 13A is a flowchart of a process of identifying a user according to some embodiments of the present disclosure. As illustrated in FIG. 13A, information of a plurality of users may be obtained in step 1311. The server may obtain the user IDs of all the users for an application. The server may also obtain user identifiers of all the current users from the user registration information stored in the database. The user ID may include an identifier used by the user when registering the application, including but not limited to a mobile phone number, a user name (e.g., one or more user names in a social network), an email address, other social application accounts, or the like, or any combination thereof. In step 1312, a unique user identifier of the mobile device corresponding to the user identifier (e.g., a unique identifier of the mobile device corresponding to the user) may be further obtained according to the user identifier obtained at step 1311. The unique user identifier of the mobile device may include, but is not limited to, an international mobile equipment identity (IMEI), a media access control (MAC) address of the mobile device, or the like, or any combination thereof. It should be noted that the unique identifier of the mobile device is not limited thereto but may include any other suitable identifications ways known in the art or developed in the future. The other suitable identification ways may include the ways that may use a mobile device identification code (MEID), an electronic serial number (EMS), an international mobile subscriber identity (IMSI), or the like. For example, when the user ID is a mobile number, the server may obtain the unique identifier of the mobile device corresponding to said mobile number from the log data. The log data may include historical interaction information associated with the mobile device and the user according to the mobile phone number. For example, the historical interaction information may often be accompanied by some information about the mobile device itself, such as the IMEI, the MAC address, and so on. As another example, when the user ID is a user name such as a nickname, the server may obtain the registered mobile phone number corresponding to the user name based on the user registration information. Like the foregoing embodiment, the unique user identifier of the mobile device corresponding to the registered mobile phone number may then be acquired from the log data that may include the historical interaction information of the mobile device and the user according to the registered mobile phone number. In step 1313, duplicate users in the plurality of the users may be identified based on the unique identifier of the mobile device. In some embodiments, the server may identify the users with the same unique identifier of the mobile device based on the unique identifier corresponding to the user/the user identifier obtained in step 1312, and the users can be identified as duplicate users.

It should be noted that there may be some problems in obtaining a unique identifier of the mobile device. For example, the obtained unique identifier of the mobile device may be an abnormal identifier (in the present disclosure, a normal identifier is a unique identifier that uniquely identifies a mobile device), the abnormal identifier may not be used to uniquely identify the mobile device, and the abnormal identifier may also not be used to uniquely identify the user. For example, some information of some mobile devices may not be allowed to be obtained due to the different management sets of different mobile devices, therefore the identifiers of the mobile devices may not be obtained. In some embodiments, the server may obtain some strings (e.g., an empty string or O) that may not be used to identify a unique user. Additionally, some mobile devices may be refurbished, in which case the unique identifiers of the mobile devices using the same Brush package may include a fixed but meaningless string such as “01234567890123”, which may also be not used to uniquely identify users. Therefore, in some embodiments of the present disclosure, the unique identifiers of mobile devices may be classified into two classes: one class (the normal identifier) is that can be used to identify a unique user; and the other class (the abnormal identifier) is that cannot be used to identify a unique user. And then the accuracy of identification of the unique user may be improved. A detailed description will be provided with reference to FIG. 13B.

FIG. 13B is a flowchart of another process of identifying a user according to some embodiments of the present disclosure. In FIG. 13, the operations of step 1321 and step 1322 are similar to steps 1311 and 1312. In step 1323, the server may determine whether the unique identifier of the mobile device is normal. If the unique identifier is normal, then the process may proceed to step 1324, where the users corresponding to a same unique identifier of the mobile device to may be identified as duplicate users. If the unique identifier is abnormal, then the process may proceed to step 1325. In step 1325, the users corresponding to a same unique identifier of the mobile device may be identified as non-duplicate users, wherein the unique identifier may correspond to a plurality of user identifiers.

According to some embodiment of the present disclosure, the server may determine whether the unique identifier of the mobile device is normal or not, based on the number of user IDs corresponding to the unique identifier of the mobile device and/or the number of the user locations corresponding to the user IDs corresponding to the unique identifier of the mobile device. More particularly, for example, the server may check the user IDs of all active users such as a mobile phone number. Then the server may count the number of all mobile phone numbers corresponding to an acquired identifier such as IMEI, and then may determine whether the counted number of user IDs is greater than a first threshold number. The first threshold number may be predefined based on the estimation of the number of close relatives and friends or any other suitable conditions. The first threshold number may include any positive integer, for example, 3, 4, 5, or any other suitable number. If the number of the counted user IDs is not greater than (less than or equal to) the first threshold number, it may be determined that the unique identifier of the mobile device may be normal and all users with the same unique identifier of mobile device may be determined to be duplicate users (i.e. the same user). If the number of the counted user IDs is greater than the first threshold number, the number of the user locations corresponding to the user IDs corresponding to the unique identifier of the mobile device may be counted. Here, it may be necessary to count the number of the locations of the mobile devices (i.e., the locations of the users), wherein the mobile devices may correspond to all the user's mobile phone numbers that may correspond to the exemplary IMEI. For example, the number of cities that the mobile phone numbers may belong to may be counted, wherein the mobile phone numbers may correspond to the IMEIs. As one example, the server may request each mobile device to upload the corresponding GPS location information so as to obtain the location information of the mobile device, and then the server may count the number of the locations of all users corresponding to the user identifiers that may correspond to the unique identifier of the mobile device. It should be apparent for those skilled in the art that the server may also obtain the location information of the mobile device by any other suitable means. Then the server may determine whether the counted number of user locations is greater than a second threshold number. The second threshold number may be predetermined based on an estimation of the number of cities that one user may cross over in one day or any other suitable conditions. The second threshold number may be any integer, for example, 3 or more. If the number of the user locations is not greater than the second threshold number, the unique identifier of the mobile device may be determined to be normal. If the number of the user locations is greater than the second threshold number, the unique identifier may be determined to be not normal.

The above description of the process of determining whether the unique identifier of the mobile device is normal is merely provided as an example. It should be noted that the unique identifier of the mobile device may be determined by any other suitable means known in the art or developed in the future. For example, it may be possible to determine whether the unique identifier of the mobile device is normal based on the number of IDs corresponding to the unique identifier of the mobile device within a time period.

A user identification subsystem corresponding to the user identification method illustrated above may also be provided according to the embodiments of the present disclosure. FIG. 13C is a block diagram of the user identification subsystem. The subsystem may include a first obtaining sub-module 1331, a second obtaining sub-module 1332 and an identifying module 1333. More particularly, the first obtaining sub-module 1331 may be configured to acquire the user identifiers of a plurality of users. The second obtaining sub-module 1332 may be configured to obtain the unique identifier of a mobile device corresponding to the user identifiers. The identifying module 1333 may be configured to identify the duplicate users from the plurality of users based on the unique identifier of the mobile device. In some embodiments, the identifying module 1333 may include a determining unit that may determine whether the unique identifier of mobile device may be normal. The identifying module 1333 may also include an identifying unit that may identify users corresponding to all user identifiers corresponding to the unique identifier of the mobile device. When the unique identifier is normal, the corresponding users may be identified as duplicate users. When the unique identifier is not normal, the corresponding users may be identified as non-duplicate users. In some embodiments, the determining unit may include a first determining unit that may determine whether the unique identifier of the mobile device is normal based on the number of the user identifiers corresponding to the unique identifier of the mobile device. In some embodiments, the first determining unit may further include a first counting sub-unit that may count the number of user identifiers corresponding to the unique identifier of the mobile device. The first determining unit may also include a first determining sub-unit that may determine the unique identifier of mobile device is normal when the number of the user identifiers is less than or equal to the first threshold number and may determine the unique identifier of the mobile device is abnormal when the number of the user identifiers is more than the first threshold number. In some embodiments, the determining unit may further include a second determining unit that may determine whether the unique identifier of the mobile device is normal based on the number of the user locations of the user's identifiers corresponding to the unique identifier of the mobile device. In some embodiments, the second determining unit may further include a second counting sub-unit that may count the number of user locations of user identifiers corresponding to the unique identifier of the mobile device. The second determining unit may further include a second determining sub-unit that may determine the unique identifier of mobile device is normal when the number of the user locations is less than or equal to the second threshold number and may determine the unique identifier of the mobile device is abnormal when the number of the user locations is more than the second threshold. It should be noted that the user identifiers may include, but are not limited to, a mobile phone number, a user name, an email address, or the like, or any combination thereof. The unique identification of a mobile device includes, but is not limited to, an International Mobile Equipment Identity (MEI), a MAC address of a mobile device, or the like, or any combination thereof.

The various modules and elements described above are not essential. Moreover, it may be rather apparent to those skilled in the art after having knowledge of the content and principles of the present application, that the system is susceptible to various modifications and changes in form and detail, the modules may be arbitrarily combined, or the subsystems may be connected to other modules. And such modifications and variations are still within the spirit and scope of the exemplary embodiments of this disclosure.

It will be appreciated by one skilled in the art that embodiments of the present application may be provided as a method, system, or computer program product. Accordingly, aspects of the present disclosure may be implemented entirely hardware, entirely software (including firmware, resident software, micro-code, etc.) or combining software and hardware implementation. Furthermore, aspects of the present disclosure may take the form of a computer program product embodied in one or more computer-readable media (including but not limited to disk storage, CD-ROM, optical storage, etc.) having computer readable program code embodied thereon.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

1-20. (canceled)

21. An electronic system, comprising:
at least one data input port;
at least one storage medium electronically connected with the at least one data input port; and
processing circuits electronically connected to the at least one data input port,
wherein during operation, the processing circuits:
access the at least one storage medium via the data input port to read and execute structured data encoding a target order associated with a target user, the target user including a target service provider or a target service requester;
determine a first plurality of historical orders associated with the target order;
determine values of the first plurality of historical orders; and
determine a value of the target order based on the values of the first plurality of historical orders.

22. The electronic system of claim 21, wherein, to determine the first plurality of historical orders associated with the target order, the processing circuits are further directed to:
determine at least one of a starting location, a destination location, or a starting time associated with the target order; and
determine the first plurality of historical orders based on at least one of the starting location, the destination location, or the starting time.

23. The electronic system of claim 21, wherein to determine the values of the first plurality of historical orders, the processing circuits further:
determine a first user submitting an order request for accepting a first historical order of the first plurality of historical orders, the first user including a first service provider;
determine a number of order requests submitted by the first user within a first time period; and
determine a value of the first historical order based at least in part on the number of order requests.

24. The electronic system of claim 21, wherein to determine the values of the first plurality of historical orders, the processing circuits further:
obtain a first activity feature and a first attribute feature relating to a second historical order of the first plurality of historical orders;
determine an initial value of the second historical order based on the first activity feature; and
determine a final value of the second historical order based on the initial value of the second historical order and the first attribute feature.

25. The electronic system of claim 24, wherein to determine the initial value of the second historical order, the processing circuits further:
determine a plurality of activity features relating to the second historical order, wherein the plurality of activity features includes the first activity feature;
assign a first plurality of weights to the plurality of activity features;
smooth at least one activity feature of the plurality of activity features to generate at least one smoothed activity feature based on the first plurality of weights; and
determine the initial value of the second historical order based on the smoothed activity feature.

26. The electronic system of claim 24, wherein to determine the final value of the second historical order, the processing circuits further:
determine a plurality of attribute features relating to the second historical order, the plurality of attribute features including the first attribute feature;
assign a second plurality of weights to the plurality of attribute features;
smooth at least one attribute feature of the plurality of attribute features to generate at least one smoothed attribute feature based on the second plurality of weights; and
determine the final value of the second historical order based on the initial value and the smoothed attribute feature.

27. The electronic system of claim 21, wherein the processing circuits further:
determine at least one order feature relating to the target order, wherein the order feature indicates at least one of location information and time information relating to the target order; and
determine the value of the target order based on a mapping model and the order feature.

28. The electronic system of claim 21, wherein the processing circuits further:
obtain a second plurality of historical orders associated with the target user;
determine at least one first input variable relating to the second plurality of historical orders, wherein the input variable relates to user information relating to the target user; and
determine a stability feature based on the input variable and a predictive model, wherein the stability feature indicates a stability degree for an online platform.

29. A method for processing service orders, comprising:
receiving, via a data input port of an online platform, data related to a target order associated with a target user, the target user including a target service provider or a target service requester;
determining, by processing circuits of an electronic device, a first plurality of historical orders associated with the target order;
determining, by the processing circuits of the electronic device, values of the first plurality of historical orders; and
determining, by the processing circuits of the electronic device, a value of the target order based on the values of the first plurality of historical orders.

30. The method of claim 29, wherein the determining of the first plurality of historical orders associated with the target order includes:
determining at least one of a starting location, a destination location, or a starting time associated with the target order; and
determining the first plurality of historical orders based on at least one of the starting location, the destination location, or the starting time.

31. The method of claim 29, wherein the determining of the values of the first plurality of historical orders includes:
determining a first user submitting an order request for accepting a first historical order of the first plurality of historical orders, wherein the first user includes a first service provider;
determining a number of order requests submitted by the first user within a first time period; and
determining a value of the first historical order based at least in part on the number of order requests.

32. The method of claim 29, wherein the determining of the values of the first plurality of historical orders includes:
obtaining a first activity feature and a first attribute feature relating to a second historical order of the first plurality of historical orders;
determining an initial value of the second historical order based on the first activity feature; and
determining a final value of the second historical order based on the initial value of the second historical order and the first attribute feature.

33. The method of claim 32, wherein the first activity feature includes at least one of the number of times to place the second historical order by a first service requester, a time interval to strive for the second historical order by a second service provider, or the number of times to strive for the second historical order by one or more service providers.

34. The method of claim 32, wherein the first attribute feature includes at least one of an order status indicating whether the second historical order has been accepted, a distance related to the second historical order, or a cost related to the second historical order.

35. The method of claim 32, wherein the determining of the initial value of the second historical order includes:
determining a plurality of activity features relating to the second historical order, wherein the plurality of activity features includes the first activity feature;
assigning a first plurality of weights to the plurality of activity features;
smoothing at least one activity feature of the plurality of activity features to generate at least one smoothed activity feature based on the first plurality of weights; and
determining the initial value of the second historical order based on the smoothed activity feature.

36. The method of claim 32, wherein the determining of the final value of the second historical order includes:
determining a plurality of attribute features relating to the second historical order, wherein the plurality of attribute features includes the first attribute feature;
assigning a second plurality of weights to the plurality of attribute features;
smoothing at least one attribute feature of the plurality of attribute features to generate at least one smoothed attribute feature based on the second plurality of weights; and
determining the final value of the second historical order based on the initial value and the smoothed attribute feature.

37. The method of claim 29, further comprising:
determining, by the processing circuits of the electronic device, at least one order feature relating to the target order, wherein the order feature indicates at least one of location information and time information relating to the target order; and
determining, by the processing circuits of the electronic device, the value of the target order based on a mapping model and the order feature.

38. The method of claim 29, further comprising:
obtaining, by the processing circuits of the electronic device, a second plurality of historical orders associated with the target user;
determining, by the processing circuits of the electronic device, at least one first input variable relating to the second plurality of historical orders, wherein the input variable relates to user information relating to the target user; and
determining, by the processing circuits of the electronic device, a stability feature based on the input variable and a predictive model, wherein the stability feature indicates a stability degree for the online platform.

39. The method of claim 38, further comprising:
determining, by the processing circuits of the electronic device, at least one second input variable and at least one output variable relating to a third plurality of historical orders associated with a plurality of second users whether the plurality of second users include lost customers, wherein the plurality of second users comprise a plurality of third service providers or a plurality of second service requesters; and
determining, by the processing circuits of the electronic device, the predictive model based on the second input variable and the output variable.

40. The method of claim 29, further comprising:
determining, by the processing circuits of the electronic device, a fourth plurality of historical orders associated with the target service requester;
determining, by the processing circuits of the electronic device, at least one target time interval at which the target service requester initiates the fourth plurality of historical orders; and
determining, by the processing circuits of the electronic device, a loss boundary of the target service requester based on the target time interval, wherein the loss boundary indicates a reference time interval to determine whether the target service requester is a lost customer.
